(19) United States
(12) Patent Application Publication
(10) Pub. No.: US 2018/0232751 A1
(43) Pub. Date: Aug. 16, 2018

(54) INTERNET SYSTEM AND METHOD WITH PREDICTIVE MODELING

(71) Applicant: RANDRR LLC, Findlay, OH (US)

(72) Inventors: Terrence G. Terhark, Sea Island, GA (US); Kurtis P. Smith, Ponte Vedra, FL (US); Mary Sheridan, Ponte Vedra Beach, FL (US); Alexander Kushnir, Jacksonville, FL (US); Christian Williams, Saint Augustine, FL (US)

(21) Appl. No.: 15/896,212

(22) Filed: Feb. 14, 2018

Related U.S. Application Data
(60) Provisional application No. 62/459,116, filed on Feb. 15, 2017.

(51) Int. Cl. G06Q 30/02; G06F 17/30; G06Q 10/10; G06N 7/00

(52) U.S. Cl. CPC G06Q 30/0202; G06N 7/005; G06Q 10/1053; G06F 17/30477

(57) ABSTRACT

A predictive modeling system having a marketability service module and a career path module. The marketability service module of the system server employs a marketability algorithm to determine how marketable a user is based on self-reported work experience and skills for a job. The career path module employs a career path algorithm to provide to the user a prediction of a most successful path from a users current position to a destination position on the basis of a career paths database of transitions provided by a career path analyzer of a batch computing platform intermittently in communication with the career paths database.

### CROSS-REFERENCE TO RELATED APPLICATIONS

This application claims the benefit of U.S. Provisional Application No. 62/459,116, filed on Feb. 15, 2017. The entire disclosure of the above application is hereby incorporated herein by reference.

### FIELD

The present disclosure relates to a predictive modeling system and, more particularly, to a computer-based system to effectively determine a probability of transition between an original state and a desired state, such as from one occupational position to another occupational position, and to indicate how to optimize the probability of the transition.

### BACKGROUND

In recent years, computerized statistical modeling and analysis has started to replace the use of traditional rule-based decision making by an individual. Predictive modeling is a form of statistical analysis that is increasingly being used in human resources, career planning, customer management, assessment of business patterns, customer loyalty, product portfolio performances, pricing variations, underwriting, and so forth. Predictive modeling involves the development of mathematical constructs that enable reliable prediction of future events or measurements based on historical information. Advantageously, the results of such predictive modeling may further be exploited for decision-making, which is related to the long-term profitability and satisfaction of an individual or organization.

Prediction of a likelihood of future events or a probability of a transition from one state to another state is performed by analyzing modeling variables. The modeling variables are related to different attributes and characteristics of the transition at issue. The number of modeling variables that may be utilized for predictive modeling has grown exponentially in many industries. In some cases, the number of modeling variables may be in the thousands. This leads to increased time and resource requirements for predictive modeling.

Further, the accuracy of the prediction for the probability of transition from one state to another state can be optimized through the use of more data or records containing the modeling variables. It may be desirable to leverage many millions of relevant records, stored in one or more databases, including databases accessible over the Internet, to more accurately determine the probability of the transition. The use of millions or more of relevant records has been determined to be essential to make such predictions accurately using the modeling variables.

Due to the unwieldy large number of variables and millions of records usually required for the making of accurate predictions, the identification of the probability of likely transitions between states is difficult, and in most cases impossible to timely determine if attempted manually. Indeed, even the use of conventional computing systems has been found unsatisfactory due to increased computation time, confounding interpretations, and increased time requirement for building and executing suitable predictive models. Such systems must continuously run for long periods and are highly inefficient. Conventional computing systems have also typically relied on standalone or proprietary databases for their modeling variables, and thus are undesirably and unable to continuously improve in accuracy over time.

Certain predictive modeling systems are known for use in the human resources industry, where large numbers of records and modeling variables are typically found. For example, in U.S. Patent Application Publication No. 20150088774 to Viridis Learning (hereinafter “the Viridis publication”), a system and method for generating a personalized career pathway is described. The career path recommendation is based on a personalized evaluation of a user's background and preparation. The Viridis publication describes a “Skills Assessment” module in which user info is input, and the output is coursework recommendations, and/or career pathway recommendations, and/or an employability scores.

In U.S. Pat. No. 8,473,320 to Workforce Associates (hereinafter “the Workforce patent”), a system and method for generating a Transferable Occupation Relationship Quotient (TORQ) is described. TORQ is a score from 0-100 that measures the transferability of works between and among occupations. It involves a mathematical manipulation of Labor Market Information (LMI) and other data, making use of O*NET and WORKKEYS values, in order to generate the score.

In U.S. Patent Appl. Pub. No. 20090037235 to Au (hereinafter “the Au application”), a system that automatically identifies a Candidate for hiring by using a composite score is described. The composite score of the Au publication is formed from a Spec Score and an Industry Score. The Spec Score generated by a Candidates answers to questions and an Industry Score based on key words and key texts from a source document, such as a job description.

In U.S. Patent Appl. Pub. No. 20120215795 to Upwardly Mobile, Inc. (hereinafter “the Upwardly application”), an intelligent job hunt (IJH) engine is described. The IJH engine receives profile information related to a user's career goals, and then determines target job criteria for the user based on the profile information. The IJH engine also determines a set of current job openings. The IJH engine computes a first matching score between a job opening and first target job criteria, and computes a second matching score between the job opening and the second target job criteria. Optionally, the IJH engine of the Upwardly application computes additional matching scores for the job opening and additional target job criteria. The matching scores are weighted and combined to generate an overall matching score for the job opening. The IJH engine sorts the set of job openings according to their overall scores and outputs the sorted list.

In U.S. Patent Appl. Pub. No. 20150127567 to Reup Education, Inc. (hereinafter “the Reup application), a data mining system is used to extract job opening information and derives relevant competencies for a given job, and derives relevant competencies for a given candidate. The result of this extraction process is a set of leveled competencies described in a structured manner for a single job description. The Reup application also describes classifying job descriptions into occupations and using the set of occupations to prioritize competencies and competency levels at an occupation level. The classification of jobs to occupations may be performed in one of two ways—1) a classification approach where annotators manually create training sets for each occupation and train a machine learning classifier (such as a Maximum Entropy classifier) to classify unseen job descriptions, or 2) using clustering approaches (such as K-Means, Latent Dirichlet Allocation or Latent Semantic Analysis) to group occupations with similar competencies together to create a model. Clustering allows the Reup system to prioritize competencies and competency levels at an occupation level.

The Reup application also describes classifying jobs to a standard taxonomy such as the Bureau of Labor Statistics (BLS) taxonomy or O*Net using manually labeled data, and then using clustering within an occupation to segment an occupation further based on competencies. From the Reup system, job seekers (“candidates”) will be able to understand what the skill requirements are for the jobs they are interested in and where necessary, have tools available to validate their skills or understand where the gaps are. Job seekers will be able to find effective solutions to close any gaps in their skill profiles.

There is a continuing need for a predictive modeling system that is capable of timely predicting transitions between an original state and a desired state based on data made available over the Internet. Desirably, the predictive modeling system will accommodate databases that continuously grow in size and complexity, including such databases available over the Internet, to facilitate a greater accuracy of the prediction transitions over time. Most desirably, the predictive modeling system may be used to determine the probabilities of transitions between job positions, including periodically recalculating time between each transition position as the relevant databases containing the records used by the predictive modeling system grow in size and complexity.

### SUMMARY

In concordance with the instant disclosure, a predictive modeling system that is capable of timely predicting transitions between an original state and a desired state based on data made available over the Internet, and which accommodates databases that continuously grow in size and complexity, including such databases available over the Internet, to facilitate a greater accuracy of the prediction transitions over time, is surprisingly discovered.

In a particular implementation, the predictive modeling system may be used to determine the probabilities of transitions between job positions, including periodically recalculating time between each transition position as the relevant databases containing the records used by the predictive modeling system grow in size and complexity.

In one embodiment, the predictive modeling system includes at least one application services server, at least one application database, a data lake, and a batch computing platform. The at least one application services server has a processor and a memory on which process-executable instructions are embodied, and is in communication via the Internet with at least one user device. The at least one application services server has a marketability service module and a career path service module. The at least one application services server generates a single page application for viewing on the at least one user device. The marketability services module is configured to generate a marketability score for provision to the user on the single page application, upon receiving a request from the user device. The career path service module is configured to provide a career path to the user on the single page application, upon received a request from the user device.

The at least one application database is stored on a memory, and has a job market statistics database and a career paths database. The job market statistics database has marketability scores stored thereon. The career paths database has a plurality of career path transitions stored thereon. The job market statistics database is in communication with the marketability service module, and the career paths database is in communication with the career path services module.

The data lake receives parsed and classified jobs data from a jobs ingress pipeline. The jobs ingress pipeline may be in communication with one or more databases available over the Internet, for example. The data lake has at least one memory with a jobs postings database in which the parsed and classified jobs data is stored, a resumes database in which parsed and classified resume data is stored, an enriched jobs posting database, and an enriched resumes database.

The batch computing platform is in intermittent (e.g., occasional or periodic) communication with the at least one application database and the data lake. The batch computing platform includes a processor and a memory on which process-executable instructions are embodied. Advantageously, the processor performance for the batch computing platform is superior to that of the application services server, in order to accommodate the more rigorous calculations and large volume (e.g., more than 10-15 million records) of data to be analyzed for prediction of transitions according to the method of the present disclosure. The batch computing platform will also intermittently spin up in order to perform or run these predictive models, using records stored in both memories of the at least one application database and the data lake, and will then save the processed data to the at least one application database for retrieval by the career path service module in real-time when requested by the user device. Thus, the batch computing platform is not continuously running, and is provides for a more efficient overall system relative to conventional internet servers.

The batch computing platform including a job posting enrichment module, a resume enrichment module, a job market analyzer module, and a career path analyzer module. The job posting enrichment module receives the parsed and classified jobs data from the jobs posting database, and computes enriched jobs data and writes the enriched jobs data to the enriched jobs posting database. The resume enrichment module receives the parsed and classified resumes data from the resumes database, and computes enriched resumes jobs data and writes the enriched resumes job data to the enriched resumes database. The job market analyzer module is configured to receive the enriched jobs postings data and the enriched resumes data and supply jobs market statistics data to the job market statistics database. The career path analyzer is configured to receive the enriched resumes data and supply career paths data to the career paths database.

In another embodiment, a method for determining a marketability of a user with the predictive modeling system includes the steps of i) receiving, by the marketability service module, inputs including a specific occupation of interest being viewed by the user on the user device, and the job markets statistics data and the saved scores in the job market statistics database; ii) determining, by the marketability service module, a raw skill score for the user, and a raw degree score for the user; iii) calculating, by the marketability service module, a modified z-score for a skill component of the user, and a modified z-score for a degree component of the user; iv) summing the weighted scores to yield the marketability score for the user, wherein the marketability score is a number; and v) fitting the marketability score for the user to one of a plurality of buckets based on the range the marketability score falls into, with the buckets identified as developing, fair, intermediate, above average, and desirable, the buckets providing the user with an efficient indication of the user's marketability relative to the specific occupation of interest.

In a further embodiment, a method for predicting a probability of a career path transition with the predictive modeling system includes the steps of i) receiving, by the career path analyzer, inputs including a pool of parsed and enriched resumes based on an occupation taxonomy from the data lake, and user profiles from a profiles database of the at least one application database; ii) extracting, by the career path analyzer, transitions for each item in the pool, and classifying each employment position to an occupation in the occupation taxonomy, extracting all occupation transitions (n-grams), and keeping all bigrams and trigrams; iii) aggregating, by the career path analyzer, the occupation transitions, calculating a number of times a specific set of transitions are observed, calculating an average time between each of the transitions, and calculating continuation/precedence probability for each of the transitions; iv) finding, by the career path analyzer, usable transitions by filtering out transitions with a low overall sample count, filtering out transitions with a low continuation or precedence probability, only keeping transitions with a predetermined occupation maturity gain, and filtering out transitions that contain loops; and v) combining, by the career path analyzer, the transitions by overlapping high probability transition trigrams to form the career paths data, the high probability transition defined by trigrams overlapping by at least two grams upon combination to provide a stable trajectory.

### BRIEF DESCRIPTION OF THE DRAWINGS

The drawings described herein are for illustrative purposes only of selected embodiments and not all possible implementations, and are not intended to limit the scope of the present disclosure.

FIGS. 1A-1B are diagrams of a predictive modeling system architecture according to one embodiment of the present disclosure, having a user device with interface, an application services server, application databases, a batch computing platform, and a data lake;

FIG. 2 is a diagram showing a use of the predictive modeling system of FIGS. 1A-1B for resume and job processing, according to one embodiment of the disclosure;

FIG. 3 is a flow diagram illustrating a method for calculating background statistics necessary to determine a marketability score of a user by application of the predictive modeling system of FIGS. 1A-1B;

FIG. 4 is a flow diagram illustrating a method for determining a marketability score of a user by application of the predictive modeling system of FIGS. 1A-1B;

FIG. 5 is an illustrative depiction of one possible career path calculated using the predictive modeling system of FIGS. 1A-1B;

FIG. 6 is a flow diagram illustrating a method for determining a probable career path of a user by application of the predictive modeling system of FIGS. 1A-1B;

FIG. 7 is an exemplary website screen shot showing a method for defining a dream job through a set of predefined search criteria using the predictive modeling system of FIGS. 1A-1B;

FIGS. 8A-8B are flow diagrams illustrating a process for connecting a user of the predictive modeling system of claim 1 with a company prior to applying for a job;

FIGS. 9-17 are tables of exemplary insights generated by the predictive modeling system of FIGS. 1A-1B;

FIG. 18 is a graphic depiction of a generated screen of the user device providing a log-in interface for the system, according to one example of the present disclosure;

FIGS. 19-23 are graphic depictions of generated screens of the user device for soliciting additional information is from the user, according to one example of the present disclosure;

FIG. 24 is a graphic depiction of a generated screen providing a system dashboard, according to one example of the present disclosure;

FIGS. 25A-25B are flow diagrams illustrating an onboarding/Import resume process flow, according to one example of the present disclosure;

FIG. 26 is a flow diagram illustrating a profile management process flow, according to one example of the present disclosure;

FIGS. 27-36 are graphic depictions of generated screens of the user device for profile management, according to one example of the present disclosure;

FIGS. 37A-37B is a flow diagram illustrating a career pathing process flow, according to one example of the present disclosure;

FIGS. 38 and 39 are graphic depictions of generated screens of the user device for career pathing, according to one example of the present disclosure;

FIG. 40 is a graphic depiction of a generated screen of the user device showing an occupation summary, according to one example of the present disclosure;

FIG. 41 is a graphic depiction of a generated screen of the user device showing a path comparison, according to one example of the present disclosure;

FIG. 42 is a graphic depiction of a generated screen of the user device showing a path summary, according to one example of the present disclosure;

FIGS. 43-45 are graphic depictions of generated screens of the user device showing saved paths, according to one example of the present disclosure;

FIG. 46 is a flow diagram illustrating a job search function process flow, according to one example of the present disclosure;

FIGS. 47-51 are graphic depictions of generated screens of the user device associated with the job search function, according to one example of the present disclosure;

FIG. 52 is a graphic depiction of a generated screen of the user device showing marketability, according to one example of the present disclosure;

FIG. 53 is a schematic diagram illustrating a process flow for determining a marketability score, according to one example of the present disclosure;

FIGS. 54-56 are graphic depictions of generated Miranda-style diagrams/graphs of the user device, according to one example of the present disclosure; and

FIG. 57 is a graphic depiction of a generated 3D experience stack graph of the user device, according to one example of the present disclosure.

### DETAILED DESCRIPTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical unless otherwise disclosed.

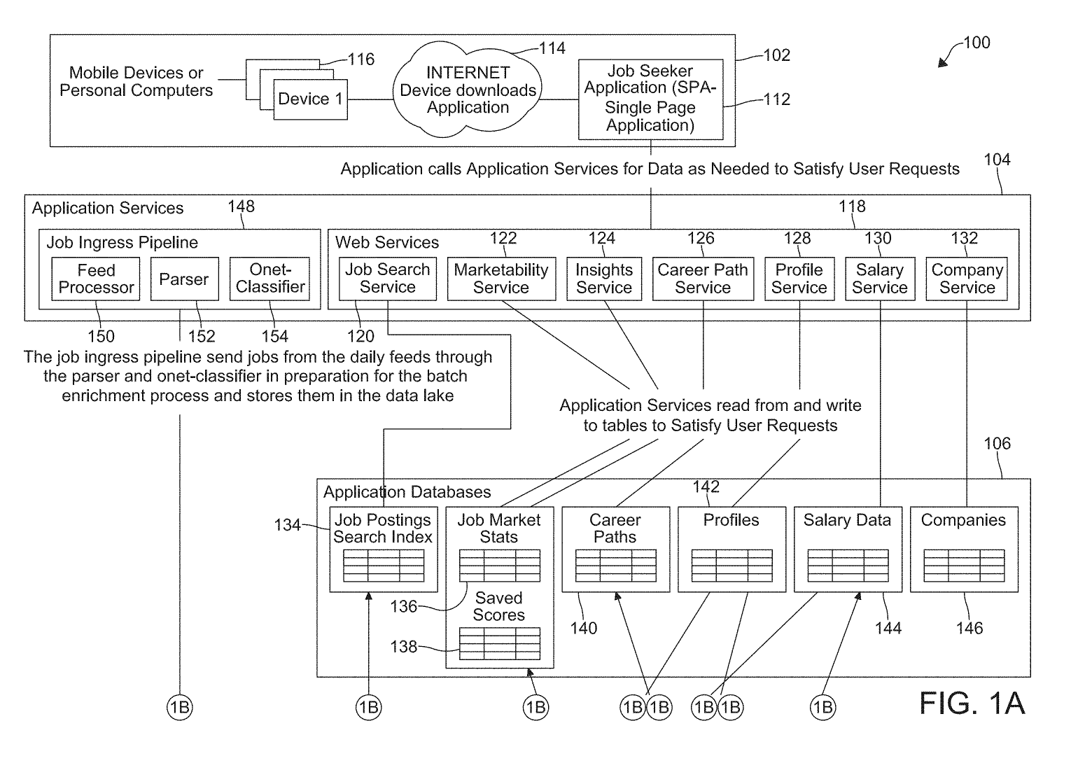

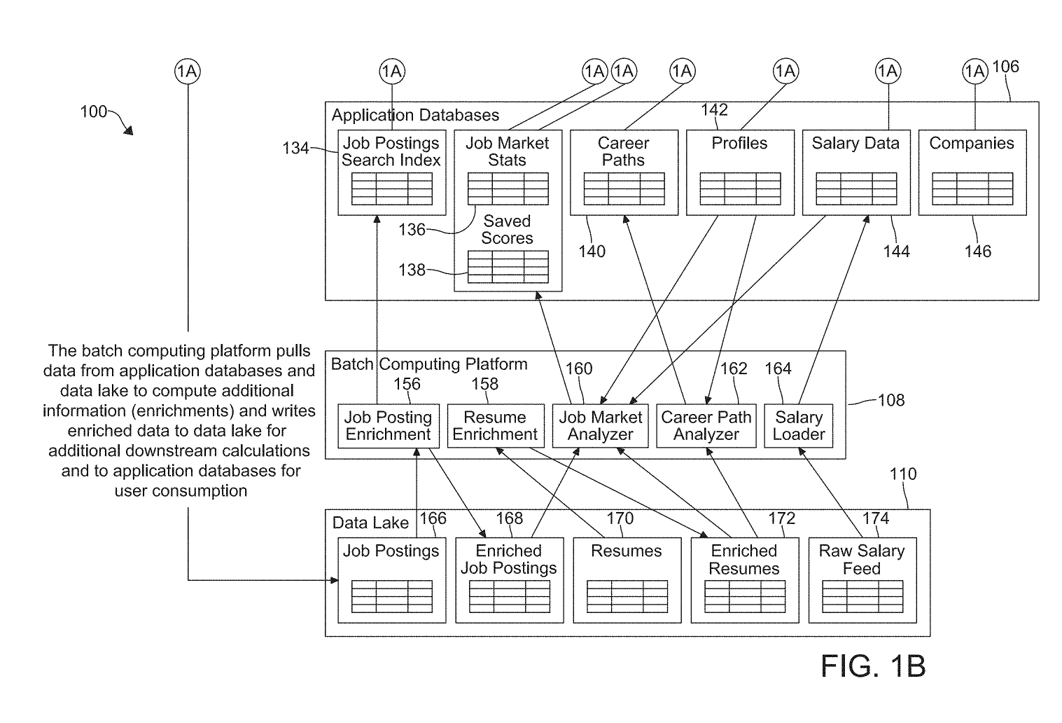

As shown in FIGS. 1A-1B, the present disclosure includes a predictive modeling system 100 having a user interface 102, at least one application services server 104, application databases 106 stored on a memory of either the application service server 104 or another server with which the application service server 104 is in communication, a batch computing platform 108, and a data lake 110. Although the predictive modeling system 100 is depicted in FIGS. 1A-1B with respect a particular human resources implementation involving marketability and career path predictions for job seekers and organizations seeking employees, it should be appreciated that the predictive modeling system 100 may also be used in other industrial implementations where millions of records and large numbers of modeling variables must be processed.

The predictive modeling system 100 may further include additional computational devices, including, but not limited to, further servers, processors, routers, switches and other hardware as is known in the art for communication with the user interface 102, the at least one application services server 104, the application databases 106, the batch computing platform 108, and the data lake 110. As used herein, the term “memory” includes a non-transitory and tangible computer-readable storage medium, on which databases and processor-executable software code, also referred to herein as a “program,” may be tangibly embodied.

The user interface 102 may include a single page application 112 available to a user of a computer network, such as the Internet 114. The user interface is in communication with the application services server 104. The single page application 112 may be accessed by the user via at least one personal computer or mobile device 116, such as a mobile phone or a tablet computer. In particular, the user may load the single page application 112 through a web browser on the personal computer 116, or through a downloadable software application on the mobile device 116. As the user interacts with the single page application 112 through the browser, a client-side script in the downloadable software application may call the application services server 10 to read and modify data stored on one or more the application databases 108. It should be appreciated that the hardware requirement for hosting the user interface 102 are relatively negligible compared to the remainder of the hardware requirements associated with the predictive modeling system 100, and one of ordinary skill in the art may select suitable hardware for the user interface 102, as desired.

The at least one applications server 104 may include one or more server computers in communication with or containing the application databases 106 of the present disclosure. The applications server 104 and the applications databases 106 may be in communication directly, over a local area network, or over a wide area network such as the Internet, as desired. The applications server 104 is configured to respond to requests from the user interface 102 and other application services by querying the application databases 106.

The at least one applications server 104 includes a plurality of application service programs or modules 118. It should be appreciated that the application databases 106 of the present disclosure are configured to store information queried by the application service server 104. Each application database is accessed by at least one topic-related service module of the application service modules 118. In some examples, and as a matter of convenience, the conceptual “application database” may be a set of tables that are stored within the same physical database instance as other conceptual application databases. However, each table set is secured to its service module and one of ordinary skill in the art can also provide each table set in separate database instances, if desired.

In a particular implementation, shown in FIGS. 1A-1B, the application service modules 118 include a job search service module 120, a marketability service module 122, an insights service module 124, a career path service module 126, a profile service module 128, a salary service module 130, and a company service module 132. The job search service module 120 is in communication with, and is configured to read from and write to, a job postings search index database 134 of the application databases 106. The marketability service module 122 and the insights service module 124 are each in communication with, and are configured to read from and write to, a job market stats database 136 of the application databases 106. The job markets stats database 136 may further included a plurality of saved scores 138, the purpose of which will be described further herein.

The career path service module 126 is in communication with, and configured to read from and write to, a career paths database 140 of the application databases 106. The profile service database module 128 is in communication with, and configured to read from and write to, a profiles database 142 of the application databases 106. The salary service module 130 is in communication with, and configured to read from and write to, a salary data database 144 of the application databases 106. The company service module 132 is in communication with, and configured to read from and write to, a companies database 146 of the application databases 106. It should be understood that each of the application service module 118 and the application databases 118 of the application server 104 are not limited to the aforementioned modules and databases, and that other suitable modules and databases are contemplated and may also be used within the scope of the present disclosure.

The at least one application services server 104 further includes a job ingress pipeline system 148. The job ingress pipeline system 148 includes a feed processor 150, a parser 152, and an O*Net classifier 154. The job ingress pipeline system 148 is in communication via the Internet with daily feeds, and sends jobs data from the daily feeds (e.g., which may be freely accessible or non-proprietary and obtained from users and companies via the Internet) through the parser 152 and O*Net classifier 154 in preparation for a batch infringement process (described herein below), and stores them in the data lake 110 with which the job ingress pipeline system 148 is in communication.

In a particular environment, multiple instances of each application service module 104 may run on an application cluster to support fault tolerance and changes in user demand on the predictive modeling system 100. As a nonlimiting example, the application cluster may be a Kubernetes™ cluster running on 13 AWS EC2 (Amazon™ Elastic Compute Cloud) instances. AWS EC2 is a web service that provides secure, resizable compute capacity in the cloud. It is designed to make web-scale cloud computing easier for developers. Kubernetes™ is an open-source system for automating deployment, scaling, and management of containerized applications. It groups containers that make up an application into logical units for easy management and discovery. Each EC2 instances may have the following specifications and host multiple application service modules: EC2 instance type—m3. large; 2 cpu, 8 GB RAM, and 100 GB HDD.

It has been found that at least these performance parameters may be desirable for the timely performance of the application services module 104 of the predictive modeling system 100. In particular, running the application services modules of the at least one applications server 104 on Kubernetes™ and EC2 allows for the scaling and cluster-size and service instance count up to easily support additional volume. One of ordinary skill in art may also select other suitable hardware specifications for the application services module 104, as desired.

Certain database technologies are also suitable for the application database 106 of the present disclosure. For example, particularly suitable hardware and software specifications may include: i) Postgresql™m a powerful, open source object-relational database system, 2×m3.2xlarge 8 cpu, 8 GB RAM, 100 GB×2 HDD; ii) Cassandra™, a database system from The Apache Software Foundation, 8×m3.large 2 cpu, 8 GB RAM, 100 GB HDD; iii) Kafka™+Zookeeper™, a distributed streaming platform from the Apache Software Foundation, 6×m3.large 2 cpu, 8 GB RAM, 100 GB HDD; and iv) elastic search, 4×m3.2xlarge 8 cpu, 8 GB RAM, 100 GB×2 HDD.

It has been found that at least these performance parameters may be desirable for the timely performance of the application databases 106 of the predictive modeling system 100. One of ordinary skill in art may also select other suitable hardware specifications for the application databases 106, as desired.

With continued reference to FIGS. 1A-1B, the batch computing platform 108 of the present disclosure is in communication with at least some of the applications databases 106 and the data lake 110, and is configured to be initialized or “spun up” either periodically or on demand, e.g., in an Amazon™ AWS EMR (Elastic Map Reduce) cluster. In other words, the batch computing platform 108 is not in direct communication with the user interface 102 nor in continuous operation, but is only selectively utilized to pull data from the application databases 106 and the data lake 110 to compute additional information (called “enrichments”), and to write the enriched data to the data lake 110 for additional downstream calculations. The batch computing platform 108 also writes the enriched data to the application databases 106 for user consumption. A skilled artisan may provide the batch computing platform 108 in communication with the application databases 106 and the data lake 110 either directly, over a local area network, or over a wide area network such as the Internet.

The programs or modules that run on the batch computing platform 108 are distributed programs, e.g., written in Apache Spark™, that execute on multiple threads and multiple machines. As non-limiting examples, the batch computing platform 108 may have a job posting enrichment module 156, a resume enrichment module 158, a job market analyzer module 160, a career path analyzer module 162, and a salary loader module 164. The data lake 110 with which the batch computing platform 108 is in communication may also include a job postings database 166, an enriched job postings database 168, a resumes database 170, an enriched resumes database 172, and a raw salary feed database 174.

Where the batch computing platform 108 has been initialized, the job posting enrichment module 156 may read job postings data from the job posting database 166, process or compute the enrichments from the job postings data, and then write the enrichments to the enriched job postings database 168. Similarly, when the batch computing platform 108 has been initialized, the resume enrichment module 158 may read resume data from the resumes module 170, process or compute the enrichments from the resume data, and then write the enrichments to the enriched resumes database 172. In particular, the modules 156, 158 enrich job postings and resumes with enhanced structure and tags for downstream use by the job market analyzer module 160 and the career path analyzer module 162.

The job market analyzer module 166, also described further herein, is configured to receive the enriched data from the enriched job postings database 168 and the enriched resumes database 172, as well as profile data from the profiles database 142 and salary data from the salary data database 144, and then calculate scores 138 as described further herein. The scores are saved to the job market stats database 136. In particular, the job market analyzer module 166 computes marketability statistics as well as other job insights served by the application.

The career path analyzer module 162, also described further herein, is configured to receive the enriched resume data from the enriched resumes database 172, and then calculate probable career path transition data, Including computed transitions and career paths from the enriched resume data. The career path transition data is then stored in the career paths database 140.

The salary loader module 164 is configured to receive raw salary data from the raw salary feed database 174, and then supply salary data to the salary data database 144. The raw salary feed database 174 may include third party salary data received from a salary data provider, for example, over the Internet.

In terms of environment, the modules that run on the batch computing platform 108 are scalable according to the size of the cluster on which they are executed. At least the following hardware specification requirements and times-to-completion for each of the modules and their services are preferred: i) job posting enrichment module 156, 12xi 3.xlarge 4 cpu, 30.5 GB RAM, and <21 minutes; ii) resume enrichment module 158, 12x i3.xlarge 4 cpu, 30.5 GB RAM, <17 minutes; iii) job market analyzer module 160, 10 m4.xlarge 4 cpu, 16 GB RAM, <30 minutes; iv) career path analyzer module 162, 4 r3.xlarge 4 cpu 30.5 GB RAM, <76 minutes; and v) salary loader module 164, 4 r4.2xlarge 8 cpu, 61 GB RAM, <30 minutes.

In a most particular embodiment, it should be understood that the total processors of the batch computing platform 108 may have at least twice the processing capability (clockspeed, GHz) of the application services server 104, and at least three times the amount of RAM available as the application services server 104, in order to ensure optimum performance, especially with the processing of more than 10-15 million records in a timely fashion.

The conceptual “data lake” 110 may be a set of tables that are stored within the same physical database instance as other conceptual application databases. However, each table can also be provided in separate database instances, if desired. In particular, the data lake 110 may be implemented on either a local storage system or on a cloud storage system, such as Amazon™ AWS S3 (Amazon Simple Storage Service™). It should be appreciated that a cloud storage system allows the predictive modeling system 100 to securely collect, store, and analyze data or records at a massive scale, e.g., tens of millions of resumes and job postings. Amazon S3 is object storage built to store and retrieve any amount of data from anywhere, e.g., web sites and mobile apps, corporate applications, and data from Internet-of-Things (IoT) sensors or devices. One of ordinary skill in the art may also select other suitable large-scale storage systems, as desired. In certain examples, the data lake 110 storage is at least about 3 terabytes. The data lake 110 is also configured to grow continuously as new job data is written to the data lake 110 from job feeds on the Internet, and as the batch computing platform 108 produced enriched data on the periodic or as-needed basis.

As shown in FIGS. 1A-1B, and according to a particular embodiment the present disclosure, the at least one applications services server 104 contains both the marketability service module 122 and the career path module 126. According to a particular implementation of the system 100 in the human resources industry, as described hereafter, the marketability service module 122 may be configured to discover a distribution of qualification scores by analyzing the most important requirements found in job postings within a particular job market against the qualifications that workers in those same job markets have. The final marketability score shown to a single user is the fitting of that user's raw qualification score by the marketability service module 122 to the distribution. As used herein, the term “job market” is defined as any particular combination of occupation and location.

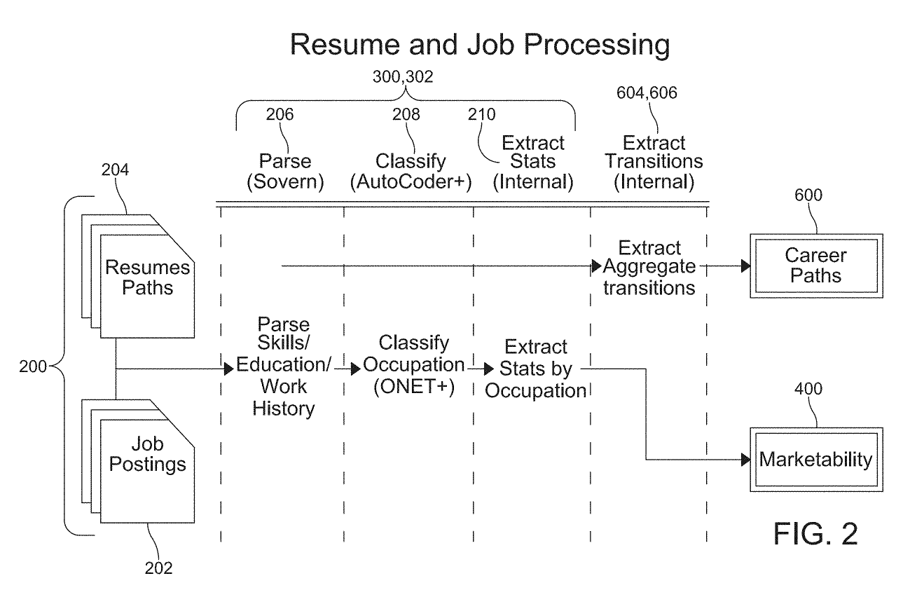

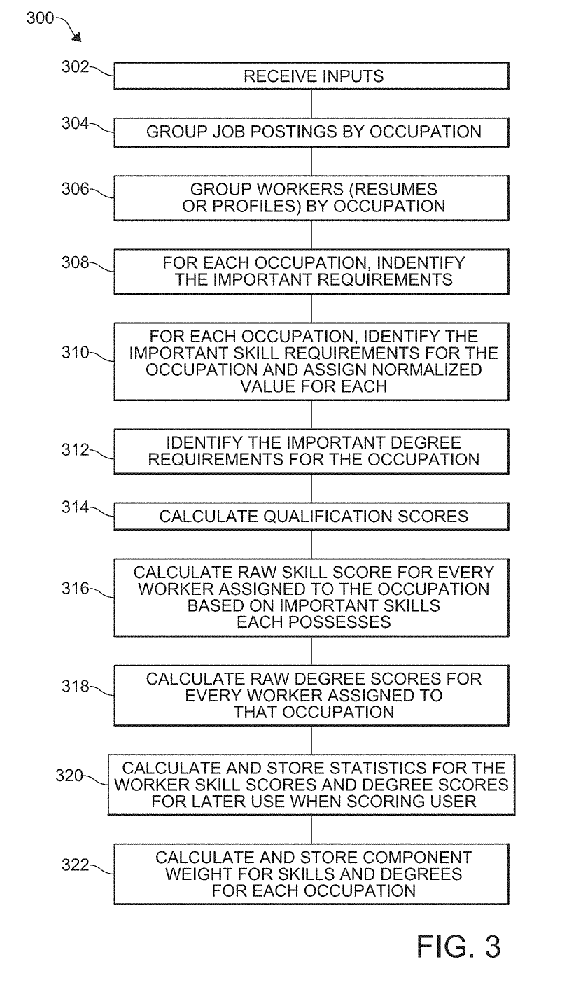

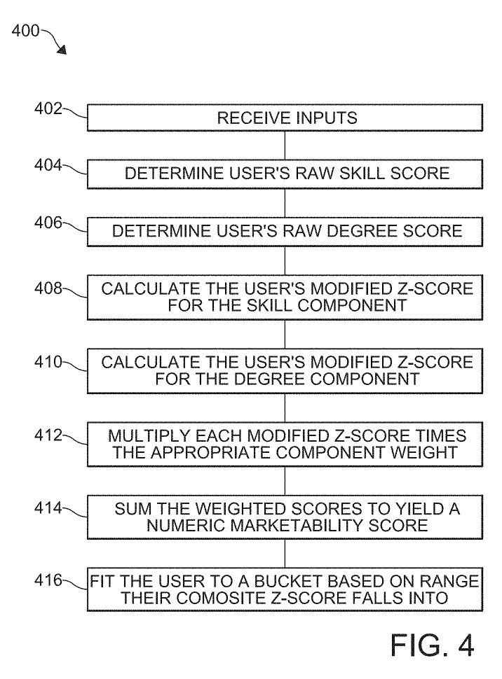

As shown in FIGS. 2-4, the marketability services module 122 has two primary components. The first component executes a method 300 for calculating background statistics, as shown in FIG. 3, and the second component executes a method 400 for scoring an online user viewing a specific occupation, as shown in FIG. 4.

For the first component, the marketability services module 122 will receive inputs 200 required for calculating the background statistics in a step 302. It should be appreciated that the calculation of the background statistics may instead or also be performed periodically by the job market analyzer 160 of the batch computing platform 108. Thus, the job market analyzer 160 may be used to perform all or a portion of the steps of the method 300, as desired.

These inputs 200 include job postings 202 and resumes 204, according to a particular implementation of the present system 100. In order to be processed by the marketability services module 122, the job postings 202 are then parsed in a parsing step 206 for skills (e.g., using Sovren™ software, a commercially available system for job and resume parsing). The parsing step 206 also includes parsing the job postings 202 for degree requirements (e.g., using the Sovren™ software). The job postings 202 must also be classified in a classifying step 208 to an occupation (e.g., using AutoCoder+™, a commercially available system developed specifically to assign O*NET occupational codes to jobs and resumes) within a predetermined taxonomy (e.g., O*NET+™, which is based on the O*NET database that was initially populated by a group of occupation analysts, and which is augmented by ongoing surveys of each occupation's worker population and occupation experts).

Likewise, as shown in FIG. 2, in order to be processed by the marketability services module 122, the resumes 204 must be parsed in the parsing step 206 for skills (e.g., using Sovren™ software, a commercially available system for job and resume parsing). The parsing step 206 also includes parsing the resumes 204 for degree requirements (e.g., using the Sovren™ software). The resumes 204 must also be classified in the classifying step 208 to an occupation (e.g., using AutoCoder+™ a commercially available system developed specifically to assign O*NET occupational codes to jobs and resumes) within the preferred taxonomy (e.g., O*NET+™ which is based on the O*NET database that was initially populated by a group of occupation analysts, and which is augmented by ongoing surveys of each occupation's worker population and occupation experts).

Following the parsing step 206 and the classifying step 208 that are associated with the step 302 of receiving the inputs, the job postings 202 are then grouped by occupation in a step 304, and workers are grouped by the resumes 204 or their profiles by occupation in a step 306. For each occupation, the marketability services module 122 then extracts in an extracting step 210 the statistics by occupation. For example, the marketability services module 122 may identify the important requirements for each occupation in a step 308, and also identify the important skill requirements for the occupation and assign a normalized importance value for each in a step 310.

The step 310 of assigning the normalized importance value may include utilizing term frequency-inverse document frequency (TF-IDF). For purposes of this calculation in the particular human resources implementation of the system 100, each occupation is considered a document and all occupations are considered the corpus. The term frequency is tallied as the number of times a particular skill appears within posting classified to the occupation. The inverse document frequency is calculated as the log of the number of occupations that mention that skill at all, divided by the total number of occupations in the taxonomy. The raw TF-IDF value for each skill is then calculated as TF*IDF. Skills falling below a certain cutoff are removed from the population of important skills. For example, the cutoff point may be the nth skill where the cumulative sum of raw TF-IDF values up to that point is greater than or equal to ½ of the total raw TF-IDF. However, it should be appreciated that the cutoff point (e.g., ½) is configurable and may be selected by the skilled artisan, as desired. Using this algorithm, the skill importance for each skill is the raw TF-IDF value for the skill divided by the total raw TF-IDF values for all skills within the occupation.

The marketability services module 122 may further identify the important degree requirements for the occupation when extracting the statistics in step 312. For degrees, TF-IDF is not used to calculate the important degree requirements. Instead, pure frequency is used to represent importance. Otherwise, the same cutoff approach used for identifying important skills requirements is used for identifying important degree requirements.

The marketability services module 122 will next calculate qualification scores in a step 314, and then calculate the raw skill score for every worker assigned to the occupation, based on the important skills each possesses in a step 316. For example, the raw skill score may be the sum of skill importance values that each worker possesses. This value will always be between 0 and 1 since skill importance for each occupation is calculated as raw TF-IDF of 1 skill divided by the sum of raw TF-IDF values for all skills in the occupation.

The marketability services module 122 will further calculate the raw degree scores for every worker assigned to that occupation in a step 318. A user is considered to “have a degree” if they have a degree that meets or exceeds the level of the one considered important for the job market. As with skills, the raw degree score is the sum of degree importance values that each worker possesses.

The marketability services module 122 will next calculate and store statistics, e.g., in the job markets database 136, for the worker skill scores and degree scores (in particular, mean, median, count, and absolute deviation) in a step 320. The stored statistics are retained for use later when scoring an online user.

The marketability services module 122 will further calculate and store, e.g., in the job markets database 136, the component weight for skills and degrees for each occupation in a step 322. The component weight is the measure of how important each component (e.g., “skill score” is one component, and “degree score” is the other) is to the overall marketability score. Component weight is calculated as the number of requirements of the particular type, divided by the number for requirements of any type. For example, where the job market (M) contains two postings (J and J′), and job posting J requires 3 skills and 1 degree, and job posting J′ requires 5 skills and 1 degree, the skill component weight of M is 0.8 and the degree component weights of M is 0.2. The component weight is used as a weight against each raw score in the final calculation, and therefore determines how much impact skills versus degrees will have on the marketability scores for a particular occupation. The sum of skill component weight plus degree component weight for one occupation equals one (1).

As mentioned above, the second component of the marketability services module 122 executes the method 400 for scoring an online user viewing the specific occupation, for example, as shown in FIG. 4. The method 400 first includes the step 402 of receiving inputs. The inputs required for the second component are the online user's profile, the occupation of interest being viewed by the online user's device 116, and the statistics calculated by the first component of the marketability services module 122 during the execution of method 300.

The marketability services module 122 will calculate the marketability score or “z-score” by first determining the user's raw skill score in a step 404. Step 404 is performed using the same methodology as for each worker when calculating background statistics. The user's raw degree score is then determined in a step 406. The user's modified z-score for the skill component is then calculated in a step 408 for both the skill component and the degree component. Each modified z-score is then multiplied times the appropriate component weight in a step 410. The weights scores are summed in a step 414 to yield the numeric marketability score. The user is then fitted by the marketability services module 122 in a step 416 to one of five buckets based on the range into which their composite z-score falls. Other numbers of buckets other than five are contemplated and may also be used in this step. For example, the buckets may be in ranges as shown below in the TABLE.

TABLE
Examples of groupings or buckets of composite z-scores.

| Range | Nominal |
|---|---|
| −Infinity to −1.0 | Developing |
| −1.0 to −0.5 | Fair |
| −0.5 to 0.5 | Intermediate |
| 0.5 to 1.0 | Above Average |
| 1.0 to Infinity | Desirable |

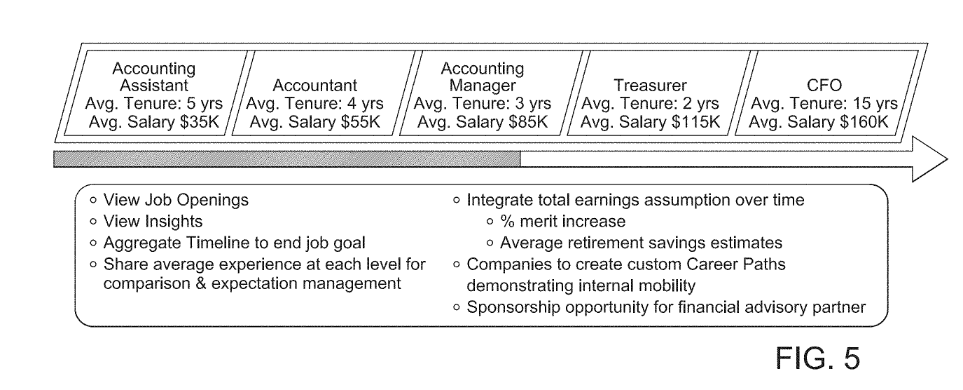

With renewed reference to FIGS. 1A-1B, the at least one applications services server 104 also contains the career path services module 126. The career path services module 126 is configured to supply users with career path choices from a collection of possible career paths stored in the system 100, based on employment history from resume and profile collections acquired and stored by the system 100. One illustrative career path is depicted in FIG. 5, and shows transitions from one state such as “Accounting Assistant” to a second state such as “Accountant,” to a third state such as “Accounting Manager,” and so forth.

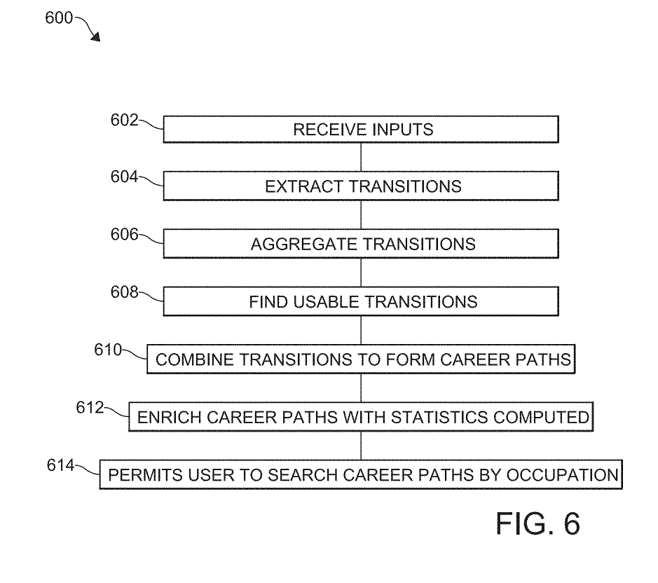

In order to compute possible career paths, and as shown in FIGS. 2 and 6, the career path services module 126 executes a method 600. In a most particular embodiment, the method 600 is intermittently (e.g., periodically or occasionally as needed) executed by the career path analyzer 162 of the batch computing platform 108, due to the large volume of records that must be analyzed and in order to provide the user with timely information.

A first step 602 in the method includes obtaining as inputs a pool of employment history documents (parsed resumes and user profiles), and the occupation taxonomy, where each occupation has some property that can indicate a “maturity” of the occupation (e.g., O*NET job zone).

The method 600 for computing the possible career paths next includes a step 604 of extracting transitions, a step 606 of aggregating the transitions, a step 608 of finding usable transitions, and a step 610 of combining the transitions to form the career paths. The step 604 of extracting transitions includes, for each item in the pool, classifying each employment position to an occupation in the preferred taxonomy. All occupation transitions (n-grams) are then extracted. All bigrams and trigrams are then kept as being most relevant to the transition modeling and predictions of the present disclosure.

In the aggregating step 606, the number of times specific sets of transitions (the n-grams) were observed is calculated. The average time between these transitions is then calculated. A continuation/precedence probability is then calculated. For example, given steps A→B, continuation probability is P(B|A), and precedence probability is P(A|B).

In the step 608 of finding usable transitions, various properties of the aggregated transitions are used to find the ones that are “usable” for career path computation. All transitions with low overall sample count are filtered out, e.g., transitions observed less than 15 times will be removed from consideration. All transitions with low continuation and/or precedence probability are also filtered out, e.g., transitions must have at least 1% probability to be usable. Additionally, only transitions with reasonable “occupation maturity gain” will be kept. For example, for a transition A→B (job zone B, and job zone A), the occupation maturity gain must either be 0 or 1 (or −1 if job zone A=5). All transitions that contain loops are also filtered out as unusable.

In the step 610 of combining transitions to form career paths, high probability transition trigrams are first combined to form a career path. It is important to recognize that the trigrams should overlap by at least two grams when combining them. This allows for a “stable trajectory” of the path. Each path is then assigned a score. For example, the career path is initialized with a bigram. The career path score is set to the probability of the bigram it is initiated with. Every time the career path is “extended” by a trigram with probability P, where P<current score, X=(current score+P)/2, else X=current score, and the new score of the extended career path is X−(1−P)/1000. The score may then be computed based on the probability of the n-grams that combine it, with the number of steps in the path and the rate of “maturity gain” taken into account as described.

In further embodiments, other factors may be used in calculating the score, e.g., skill gap, average transition time, etc.

In a step 612, the data for each step in the career path is then enriched with statistics computed in the marketability services module 122. The highest scoring career paths are then stored in job market stats database 136 as the saved scores 138. Advantageously, this allows for a user to search career paths in real-time in a step 614, by querying the application databases 106 by occupation.

The job search service module 120 of the predictive modeling system 100 further employs search functionality that permits a user to conduct a job search, for example, through the job search service module 120 and the associated job postings search index database 134. One example of suitable search functionality is the commercially available ElasticSearch™ search engine based on Lucene™, which provides a distributed, multitenant-capable full-text search engine with an HTTP web interface and schema-free JSON documents. However, a skilled artisan may also use other search functionality within the scope of the present disclosure.

In particular, as jobs are entered into the predictive modeling system 100, they are parsed and enriched as described hereinabove before they are inserted into the job posting search index database 134. A relevance score is then used to determine what results are shared with the user upon performing a query using the search functionality, as well as the order of the results.

Fields that may be used for the search that affect the relevance score may include: a) job title; b) company name; c) parsed skills; and d) job posting text. Fields that may be used as filters during the search that do not affect the relevance score may include: a) location; b) skills; c) companies; and d) posting date. For the analysis, and during the indexing, the text in searchable fields goes through various analysis pipelines. In these pipelines, certain transformations of the text are performed, including: i) tokenization; ii) lowercasing; iii) stop word removal; iv) stemming; v) synonym normalization; and vi) shingle (token n-gram) extraction.

Furthermore, the scores may be decayed on the basis of posting date. For example, scores of jobs posted more than x days ago (e.g., x=14) may be decayed based on their age up to 25 percent.

The relevance of the results returned by the search may also be controlled. For example, when a search query is issued against the search functionality, it will return multiple results, each of which has a relevance score. Determining a score threshold is what allows the system to control the “relevance” of results. As a non-limiting example, the following steps may be taken to determine a good threshold. First, issue a query and only return top match, and record the score as a baseline. Second, if the search contains a location filter, perform the same search without the location filter (i.e., a national search) and obtain an average score for top n results (e.g., n=5). If the baseline score is less than a predetermined percentage (x %) of national average from previous step, then make the national average the new baseline (e.g., x=75). Third, compute a threshold (y %) of baseline score (e.g., y=50). Fourthly, issue the search query again and only return results above the computed threshold.

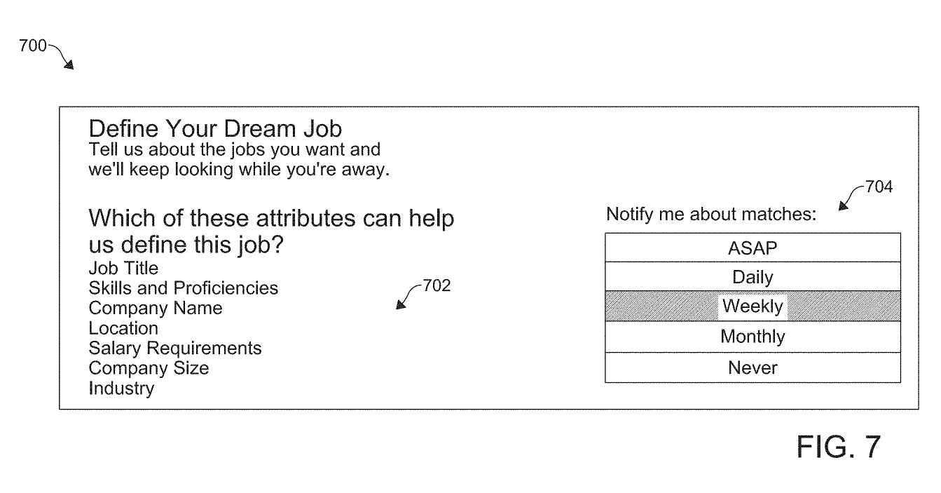

The job search service module 120 of the predictive modeling system 100 additionally has a dream job functionality, as shown an exemplary user interface 700 in FIG. 7. The dream job functionality allows a user to define a “dream job” through a set of predefined search criteria 702. Based on these criteria, the user will receive from the system 100 job alert notifications 704 when a job matching these criteria becomes active. As non-limiting examples, these predefined search fields may include job title, skills, company name, location, salary requirements, company size, and industry. Further search fields are also contemplated and considered within the scope of the present disclosure.

In particular, the dream job functionality is executed by the user selecting “Define a dream job” or the like on the user device 116. The user is then permitted to complete applicable attributes to define a job, including: a) job title; b) skills and proficiencies; c) company name; d) location; e) salary requirements; f) company size; and g) industry. The user is also permitted to select preferences for notifications. The webs services server 104, and particularly the job search service module 120, then automatically searches for a job in the job postings search index 134 that matches the criteria entered, and the user is then notified via the user's device 116.

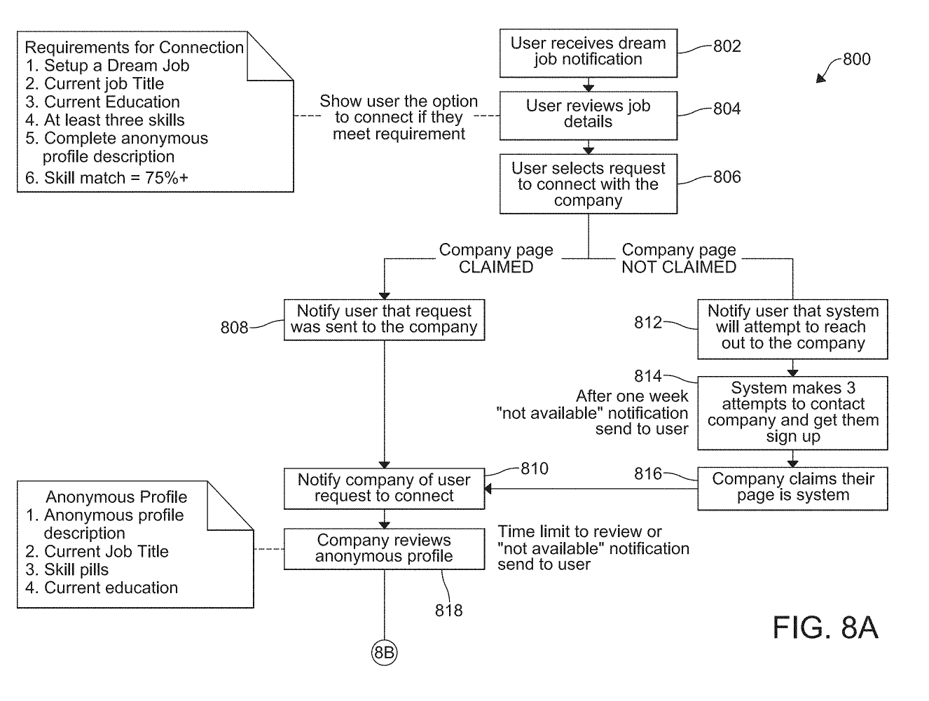

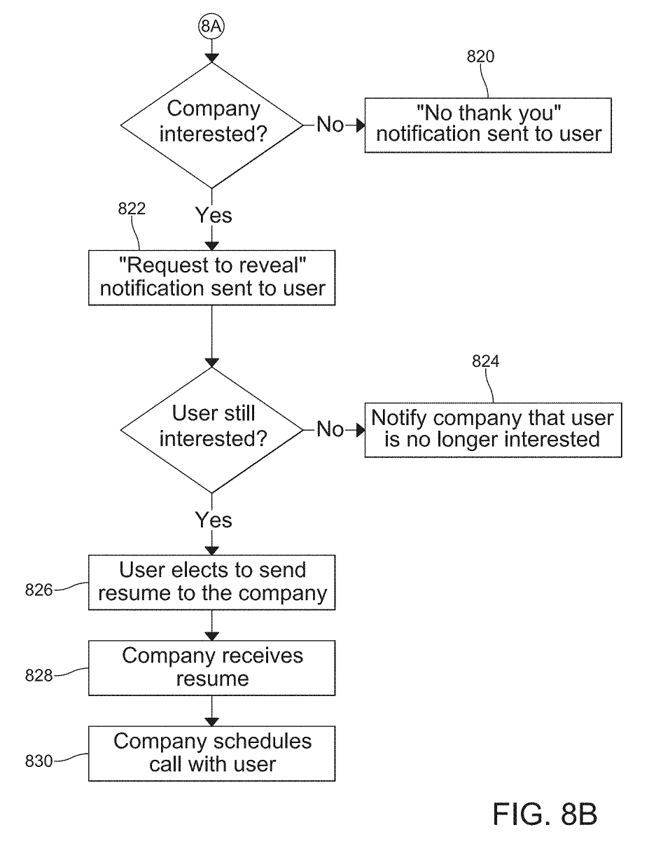

The company service module 132 of the predictive modeling system 100 also provides a method 800 for users to connected with a company prior to applying for a job, for example, as shown in FIGS. 8A-8B. In a step 802, a user may receive a dream job notification from the job search service module 120. The user may review the job details on the user's device 116 in a step 804. In a step 806, the user may then request to connect with the company via the user's device 116. Where the company page is claimed on the predictive modeling system 100, the company service module 132 of the application services server 104 may then notify the user that a request was sent to the company in a step 808, and then the application service server 104 may notify the company of the user request to connect in a step 810. Where the company page is not claimed on the predictive modeling system 100, the company service module 132 will notify the user that the system 100 will attempt to reach out to the company in a step 812. The system 100 will then make multiple attempts (e.g., 3 attempts) to contact the company and have them join the system 100. After one week, if no contact from the company, a “not available” notification is sent to the user. If the company claims their page in the system in step 816, then the method proceeds to step 810 and the company is notified of the user request to connect. The company is then permitted to review an anonymous profile in a step 818. The anonymous profile created by the system 100 may include an anonymous profile description, a current job title, skills, and current education for the user. The company is also given a time limit to review or send a “not available” notification to the user.

If the company reviews the anonymous profile and is not interested, then the method proceeds to step 820 and a “no thank you” notification is sent to the user. If the company reviews the anonymous profile and is interested, then the method proceeds to step 822 and a “request to reveal” notification is sent to the user. If the user is no longer interested in the company, then the system 100 will notify the company that the user is no longer interested in a step 824. If the user is interested in the company, then the user elects by the system 100 to send a resume to the company in a step 826. The company will then receive the resume from the system 100 in a step 828, and likewise can schedule a call with the user in a step 830. In this manner, the system 100 may be used to connect a user with a company prior to actually applying for a job with the company.

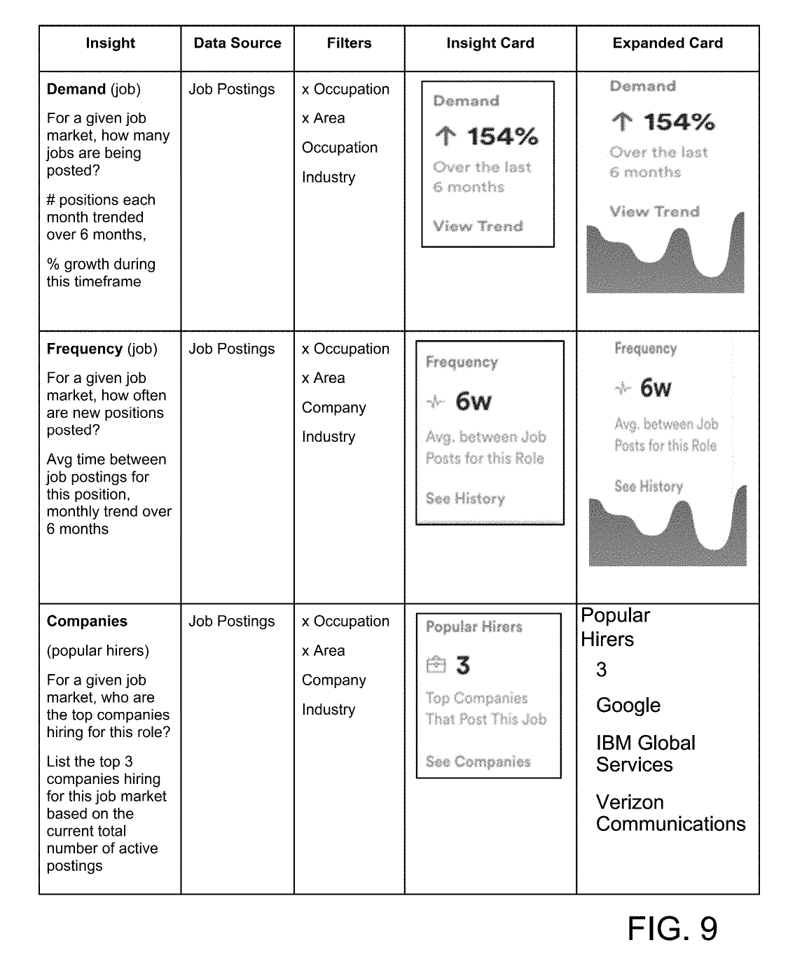

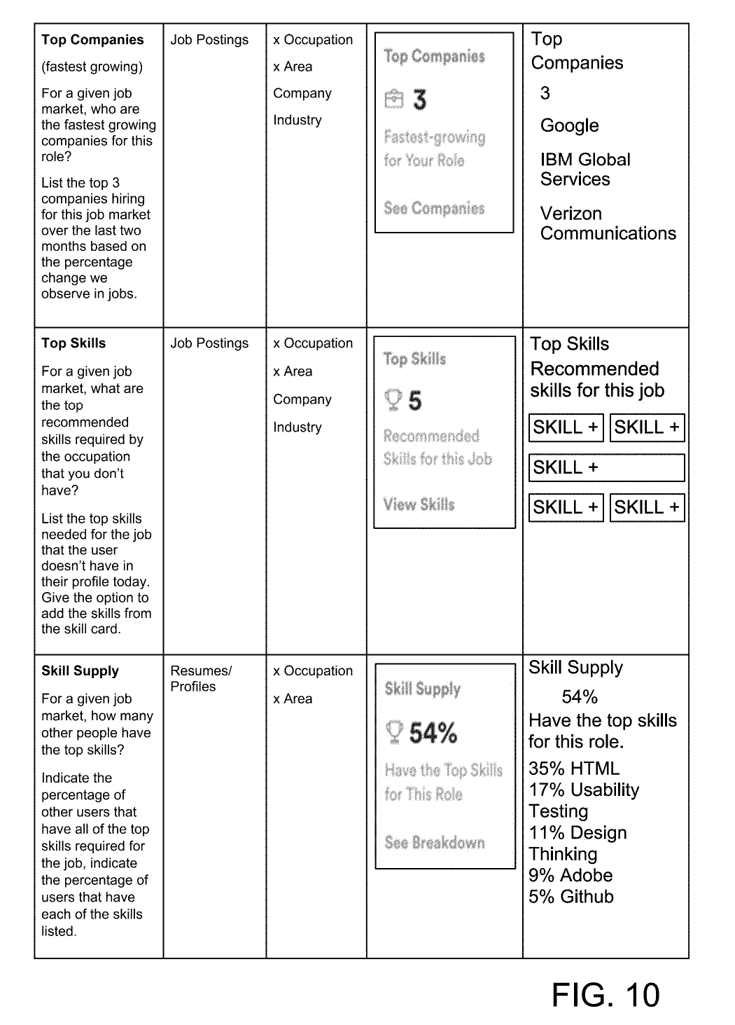

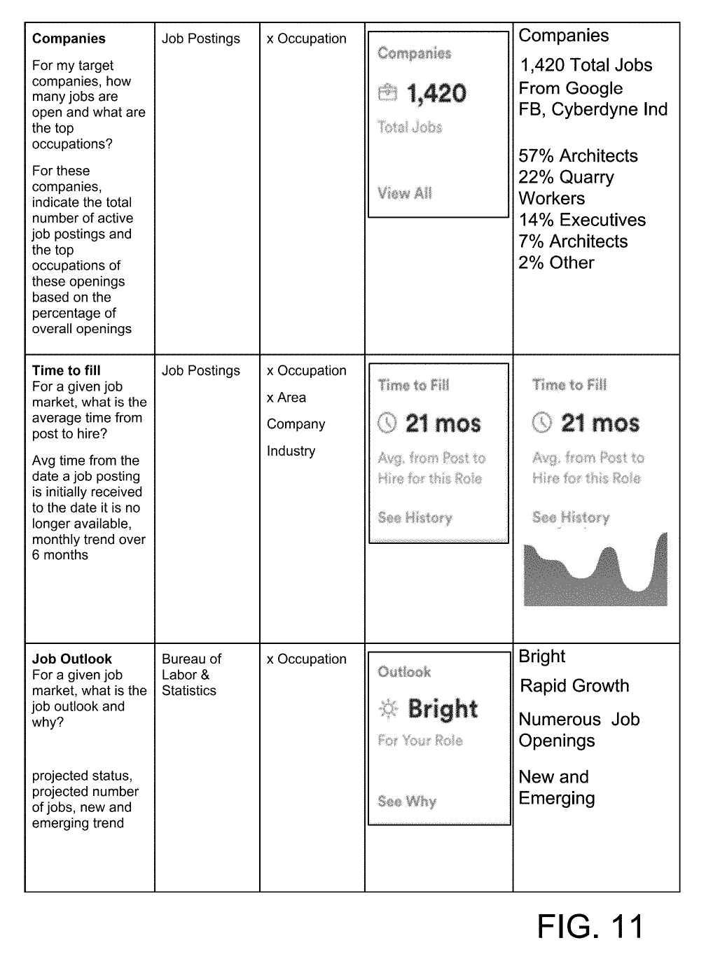

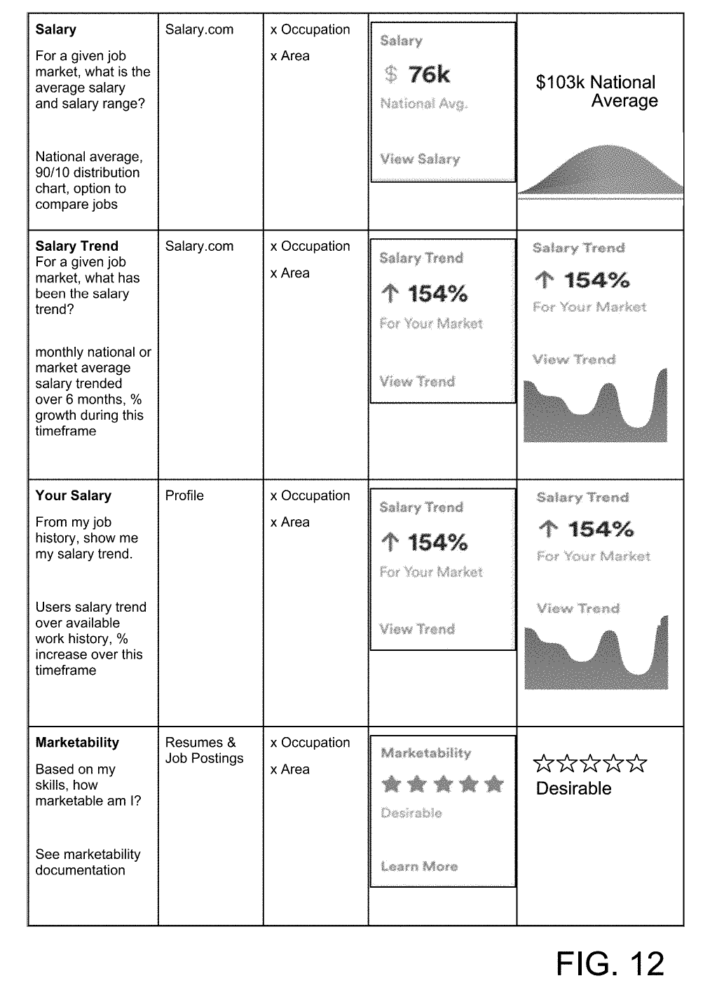

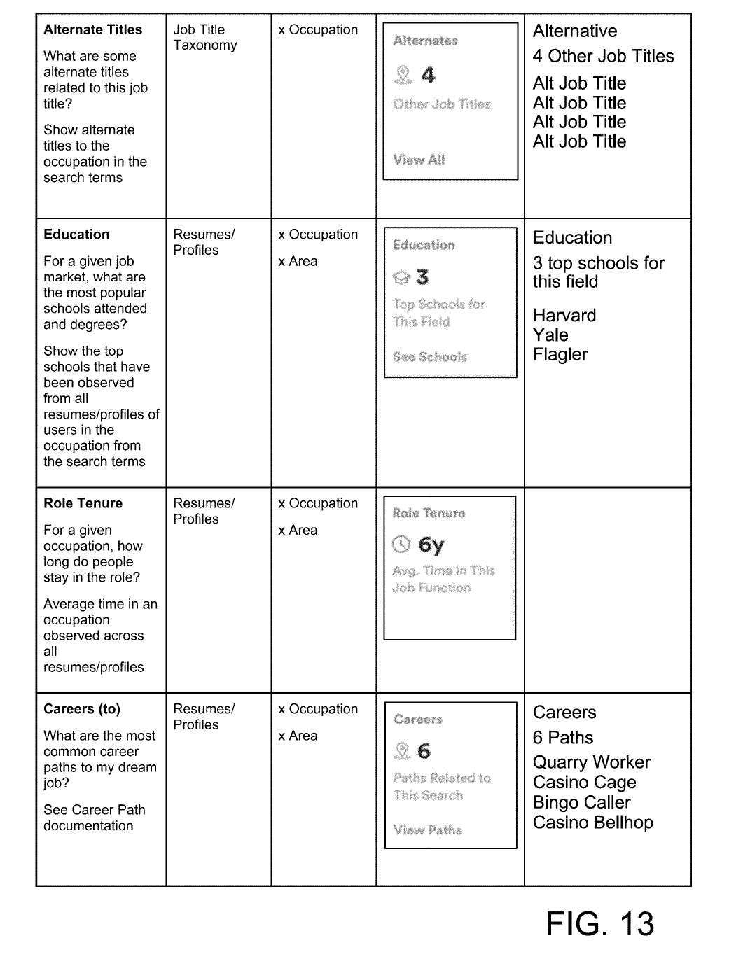

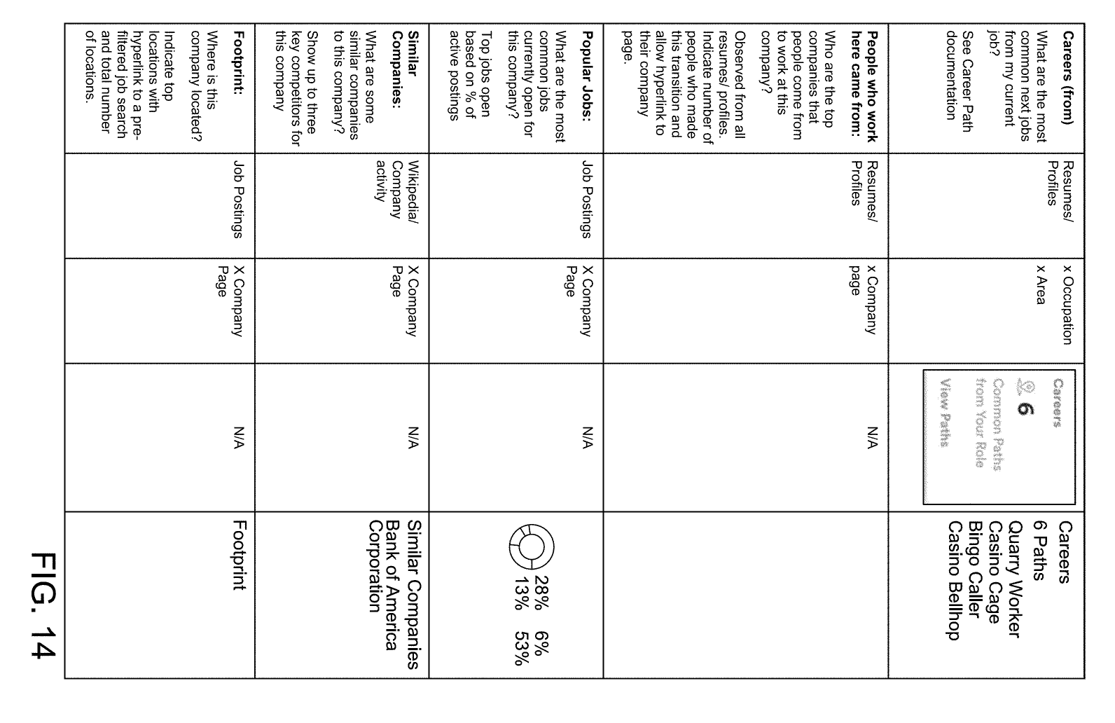

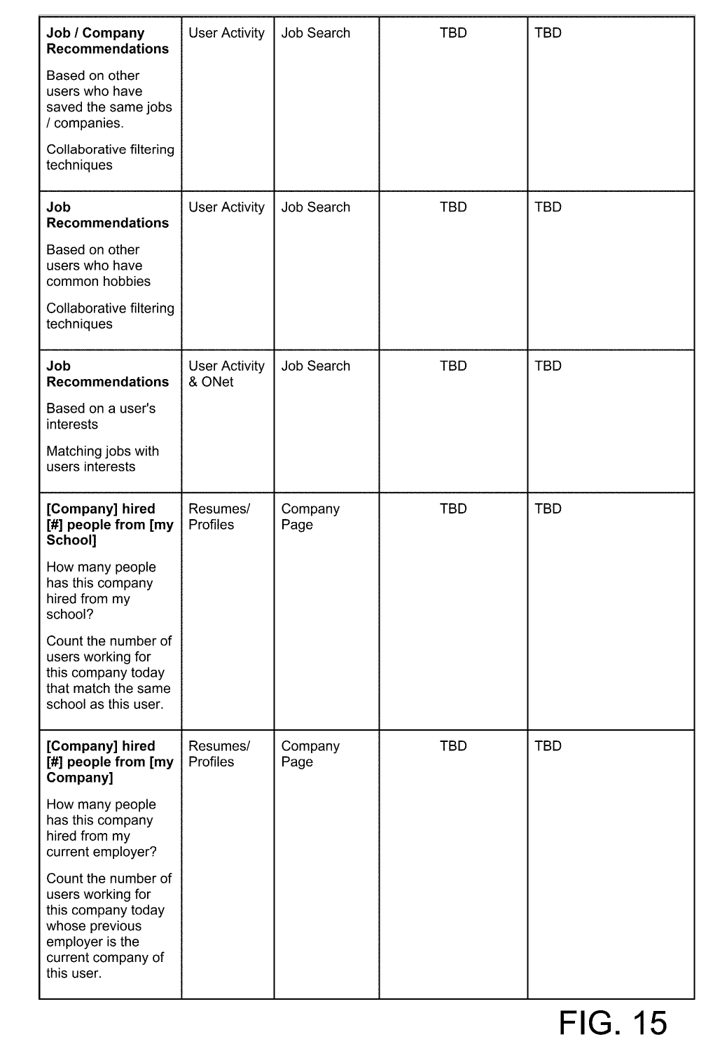

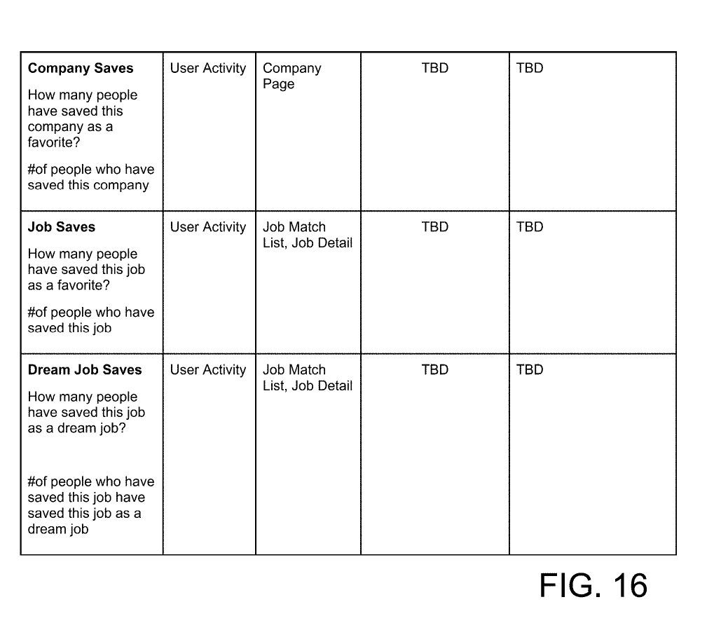

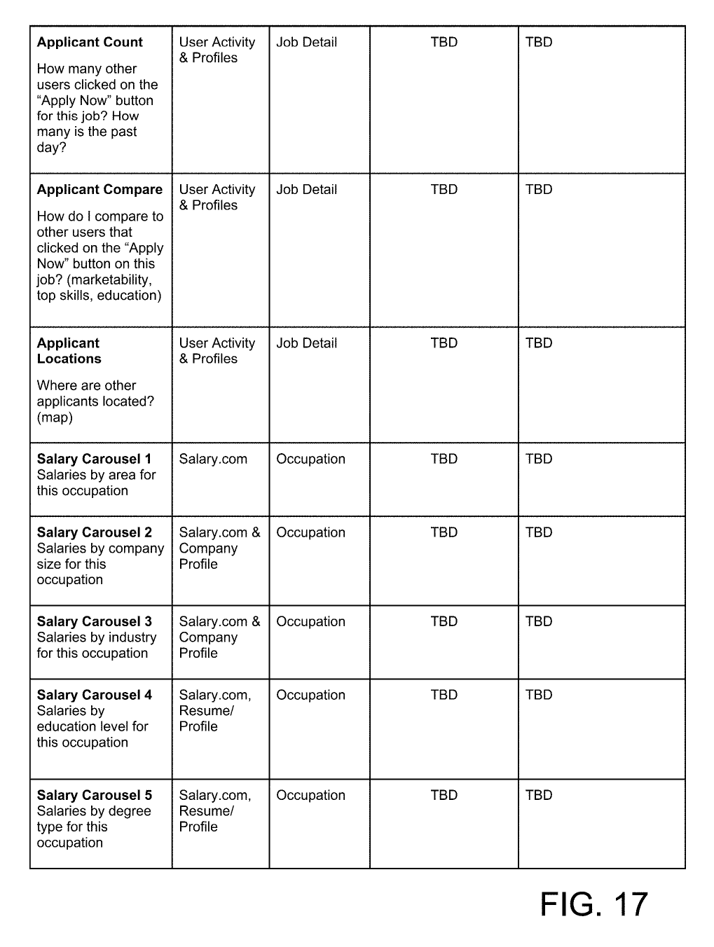

The predictive modeling system 100 further includes the insights service module 122, which is configured to provide users with the insights they need to plan and manage their career choices. The insights are dynamic based on search criteria or changes that the system 100 observes through the processing of resumes, job postings, salary surveys, and BLS data. These insights are generated on the user's device 116 and can be found throughout the application shown on the user's device. A non-limiting list of insights generated and displayed by the system 100 are shown in FIGS. 9-17.

### EXAMPLES

As described hereinabove, the predictive modeling system 100 of the present disclosure will have a variety of real-world and industrial applications, especially where very large amounts of data (e.g., more than 10-15 million records) must be analyzed but the user requires a summary or meaningful analysis in near real-time. Furthermore, the predictive modeling system 100 has been found particularly useful in the human resources industry, and more particularly as an Internet-based system 100 and method for job seekers and recruiting.

The marketability service module 122 takes advantage of the unique algorithms described herein to determine how marketable a user is based on self-reported work experience and skills for a job. The career path service module 126 also takes advantage of the unique algorithms described herein to predict a most successful path from a user's current position to a destination position on the basis of the database of transitions.

These and other advantages are detailed hereinbelow with respect to multiple examples involving the system 100. However, it should be understood that the system 100 may have other features, implementations, and uses relative to the following example without departing from the scope of the present disclosure.

In the following non-limiting examples, the system 100 creates a marketability score for each user based on skills, which is then used to both a) pick job postings for which the user is most qualified, and b) provide guidance on the common and most successful paths from a user's current occupation to a destination occupation.

With respect to a), a user's resume is first classified to a most relevant O*Net occupation code. All job postings in the system are also assigned an O*Net Occupation classification. These job postings are then grouped or clustered within O*Net segments, in order to group similar job descriptions (e.g., O*Net occupation code may be “Software Developer,” but the created segments may be clusters like “Java programmer” or “Data analyst”). Within each specific cluster, the frequency of required and preferred skills is calculated. Weights are the assigned to skills based on frequency and importance. The presence of skills and requirements from a user's resume are compared to the relevant job posting cluster extracted weights to calculate a score—e.g.: (0.5)skilla+(0.21)skillb+(0.05)skillc=Marketability Score. For general marketability, a user is compared to the job cluster they currently belong in. For career pathing (described below), a user is compared to the job cluster in each node of the selected career path.

With respect to b), a user is given the option to self-select or explore other occupations through recommendations of the system (called “Career Path” destinations) that are generated by the predictive modeling of the system. The probabilities of transitions between job positions are aggregated from user resumes that are stored in the system using graph theory methods. A “transition” is defined as movement from one job to the next. All user job position transitions are stored in the system, with the time between each transition Resume position being recalculated periodically as the database grows through submission of new Resumes. When a Career Path destination is chosen by a user, the paths with the strongest probabilities of transition from the user's current position and the selected destination are graphically presented for the user. When no destination is selected, transitions from a user's current position with the highest probabilities are also graphically displayed as “recommended” paths.

With these features, the system also can permit a 1-to-1 comparison of a Resume to an individual Job Posting, and provide the user both 1) how marketable they are compared to that individual Job Posting, and tips for improving their score in order to become more marketable, and 2) the likelihood of the transition from their current position to the position of the Job Posting.

The system creates meaningful relationships and a better way for users and companies to interact. The system also puts the power in the hands of users looking for career opportunities. With the system, users can gain transparency into companies they love, research and discover opportunities, engage employers or get hired—all while keeping their privacy intact. No more getting profiled by endless headhunters. No more resume black holes. No more wondering where users stand after they express interest in an opportunity. The system helps users discover their career destiny.

The power of the system or platform isn't just in the individual features. All of the features work together to help users attain their goals. Users from all stages of their career can discover career paths. Whether this is for their dream job, or one that is recommended by the system platform—users will have access to determine next steps in their careers. Users can view the estimated salary potential for these career paths, and also insight as to gaps in skills and education, to obtain these goals. This ties into a user's Marketability feature. It helps users understand how qualified (“marketable”) they are based on their self-reported work experience and skills for a specific occupation category.

The system also calculates a Job Qualification Score against job postings. When looking for a Job Recommendation, the system platform assesses user's skills to the job posting requirements. Using this unique algorithm gives users transparency into their current skills, and assist them with planning their career goals. Given the results of the system features, users are advised to review other the system platform features to give them more feedback and direction on how to be successful. An example would be when no high marketability job matches are available. Users might be looking for a job where they don't have the necessary skills. Going back to the Marketability feature will assess their skills and experience to the job title. Recommendations will be made around gaps for being more marketable in that job industry. Other job titles will be recommended based on a user's current profile. Giving users this insight truly helps them understand what goals they need to set to secure the job of their dreams.

Salary is another area where users can gain more insight. This is referenced with Career Paths, as well as with Job Recommendations. To better understand the salary earnings and trends assists users in making future career decisions.

The system is a unique hardware and software combination that available in a mobile app and desktop version. Privacy is a huge part of the system's platform. Users will decide when and how they want to share their information. Recruiters will never have access to search user's resumes.

The system is the first of its kind and fundamentally changes the way users interact with companies. Users' data is theirs, and will never be shared unless they want it shared. Users will decide what data to share with who, and when. No one will have access to an individual's data unless the individual authorizes it—including company recruiters. What makes the system distinct is that no other company offers the combined features, as well as keeps the individual's privacy. In addition, the unique advanced algorithms used to determine a person's marketability or job recommendations has been created by the system's data scientists which is what sets the system apart from other competitors.

The value that the system provides users is that they have one place for all of their career initiatives and tracking. Within the system platform, users can check their Marketability against occupations. This is based on a unique algorithm employed by the system. Having this insight is key for assisting users in realizing their career goals. If users are not marketable within their current job or desired job, the system will advise them on next steps to become more marketable or options to view other career paths that fit their skills.

Users from all walks of life are able to view optimal Career Paths for their future or their dream job. This could be for students in High School or College, users starting out in their careers, users wanting to change industries or careers, or users wanting to get to a dream job. The algorithm that the system uses is unique from any other competitor in the business. This allows users to discover other aspects of the career paths. Users can enter a job title, industry (will display associated job titles within that industry) or allow the system platform to recommend career paths based on users' skills, education, and experiences. Users can investigate various paths which could get them to their dream job the fastest, a path that might have higher compensation, or paths with have been taken by the most peers. From there, they can move onto other features of the platform and view the salary comparisons for different jobs in their area or across the country.

For the Salary Comparisons, the system is leveraging external data from BLS.gov as well as other databases. Utilizing the unique system algorithms, the system platform is able to provide salary comparisons based on users' current skills, education, experience. This allows users to see if their current salary is within the range with the national average, as well as the local average. If a salary is not within an acceptable range, the system will offer advice on next steps for them to take. It could be advice around how to prepare and ask for a salary increase or go back to their Career Path to discover paths that have the highest compensation opportunities. It might be that they will want to look for another job. They would then be directed to the Job Recommendation center in the system.

The Job Recommendation feature will use user's profile details as well as their preferences, and will determine the best jobs where they have the best opportunity of success. Users will be able to view their Job Qualification Score for each job recommendation. This is based on the system's unique algorithm to determine how user's skills and experience measure up against each job opening. Again, this is another place where the system is unique in the job search space. Today, users get frustrated with the process, as they apply to any job with the same job title. the system takes this several steps further. User's skills, education, experiences, licenses, certifications and preferences are all taken into account, and then compared against all job openings. They are then presented with the jobs where they have the highest match. They can save the jobs that interest them for future reference.

Users can search for jobs as well. Users have the option to setup preferences for searches, see emerging jobs, and also new jobs that match their preferences. The system will not share the users' information with companies or headhunters unless specified by the users, giving them the utmost control of their privacy.

Prior to the present invention, there was nothing like the system and methods disclosed herein. There are a multitude of job boards on the market for job seekers to look at an apply for jobs. The job boards like Career Builder™, Monster™, Indeed™, LinkedIn™, etc. work to put the companies needs first not the job seeker. Today the job search process is inadequate. About 76% of users find online job search frustrating, 93% of users don't find job search intuitive, and 90% of users don't find job search transparent. Job seekers fill out an application online and their resume is parsed by online crawlers and they are recommended jobs that they do not qualify for or are not even interested in because the current system is broken. Users should know whether they would be a competitive candidate for a job before they spend time applying for it. Understanding their marketability will let them compare themselves against their competition and help them identify areas where they can improve their skills. Also, today's career path options are typically within a company or for students only. There aren't good options for users at various stages in their career to find other career paths that they could potentially take based on their current skills. There aren't good options to indicate their dream jobs, and find all of the career path options. There are also users that want to change industries. There aren't any applications that assist users with these career paths. While other platforms have a few of these issues, no other company in this space combines all of the features that the system offers to provide a unique and game-changing experience for users. The system is the only product that allows users to remain anonymous during the job research and application process. Plus, the system will never allow recruiters access to user's data. Users own their data, and can decide if and when they want to share the data, and with whom to share it with.

Job Marketability is another feature that isn't available within the marketplace with the in-depth analysis that the system provides. The system not only takes skills, education, experience, certifications and licenses into account, but also an array of other attributes. This allows the system to provide a much more accurate view into a person's marketability. This feature then correlates to other the system product features. Understanding a person's marketability against open jobs allows the system to recommend jobs to users where they will have a high chance of success.

Users are frustrated with searching for jobs. An object of the present invention is to change that. By empowering users to interact with companies, the system will revolutionize and reinvent recruiting forever. The system is creating a technology to increase opportunity for all. The system is a mobile-first platform that can also be accessed via desktop. It will be a destination site for jobs and opportunities. The product also creates meaningful interactions between users and companies. The object is to be transparent and empowering while creating actionable data. Privacy is one of users' number one concerns. Users will choose how they share their information and who they share it with.

A primary differentiator is that the system is the only system in this space that encompasses all of these features into one product. Plus, this is the only product that is solely for the users and will never allow company recruiters access to the system's users profile data. Users will decide if, when and with whom they share their data. And last, the system offers a place for users to truly track their careers—end-to-end. From high school career planning, tracking their education and skill progress, applying and tracking all of the jobs applications, identifying their marketability at any time during their career, all the way to finding a job during retirement. It is a true career lifecycle.

The system platform architecture is unique in the industry as well. Utilizing many different technologies to allow the platform to efficiently, and offer the best user experience. One key is in the Cassandra™ Data Lakes that the platform is leveraging. This allows the system app to manage large amounts of data, and efficiently process algorithms. The key to the algorithms is tapping into the big data. From the Job Posting data to user's resume and profile data, the system is able to view trends, link skills to job titles, discover emerging skills for job, determine user's marketability and make meaningful job recommendations.

The system has a variety of tools for users to take advantage of when using the system, which are described in the following examples.

Account:

There are many options for users to create a profile and authenticate with the system platform. The system platform may allow users to authenticate in different ways, such as with Google® login, Facebook® login, and email address or mobile phone number, or even Password-less. Notifications may be provided to users with a code to authenticate.

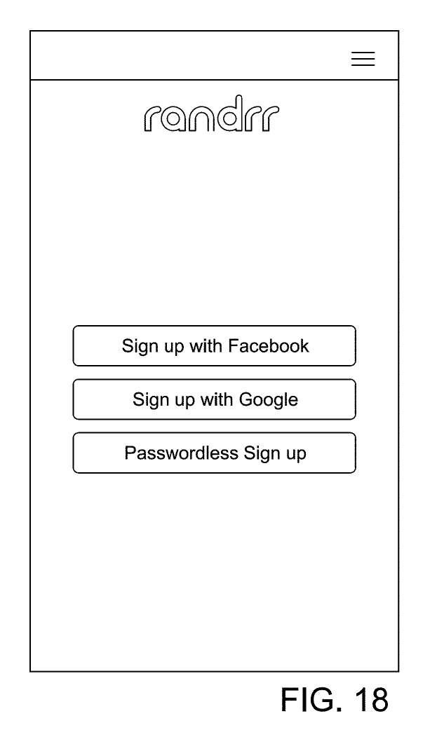

The system allows users to edit the way that they login (e.g., login with mobile phone number, but change to an email address). If a person logs in with a different device for the first time, they may re-authenticate. Users are also permitted to close their account, with an option to either not purge information or to purge information (e.g., in compliance with EU Privacy Shield). There will be an option to link accounts if a user has registered with 2 different authentication methods. Notification to individuals confirming that their information was purged, and to utilize the system in the future requires a new login, is also provided. An example of a log-in interface is shown in FIG. 18.

Guided Experience:

Users access the system platform and can either login (if already registered) or if they are a first-time visitor, they have the option to go through a guided tour to match them to the features that best fit their current situation. Users are asked 3 questions to derive the persona that their situation identifies with. Once a persona is identified, the users will go down one of 4 different paths, namely: Marketability; Career Path; Job Recommendations; and Salary Comparisons.

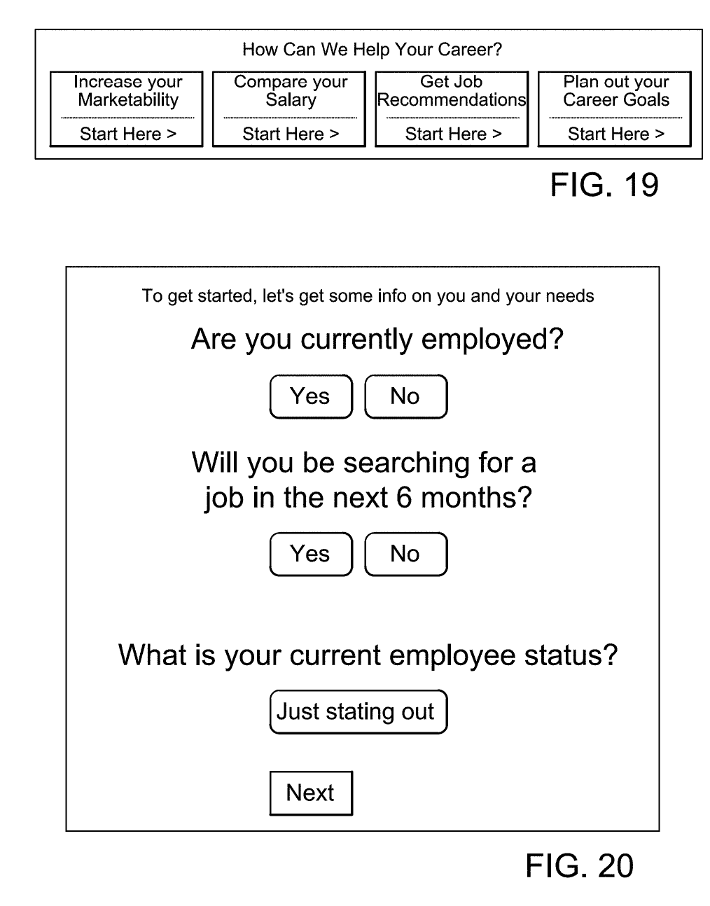

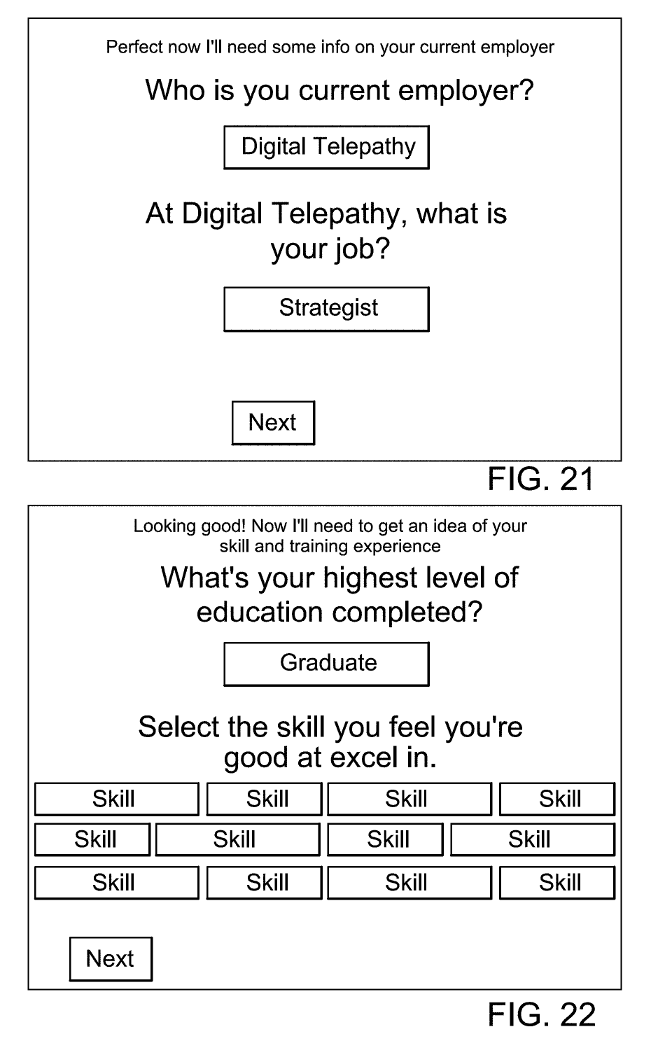

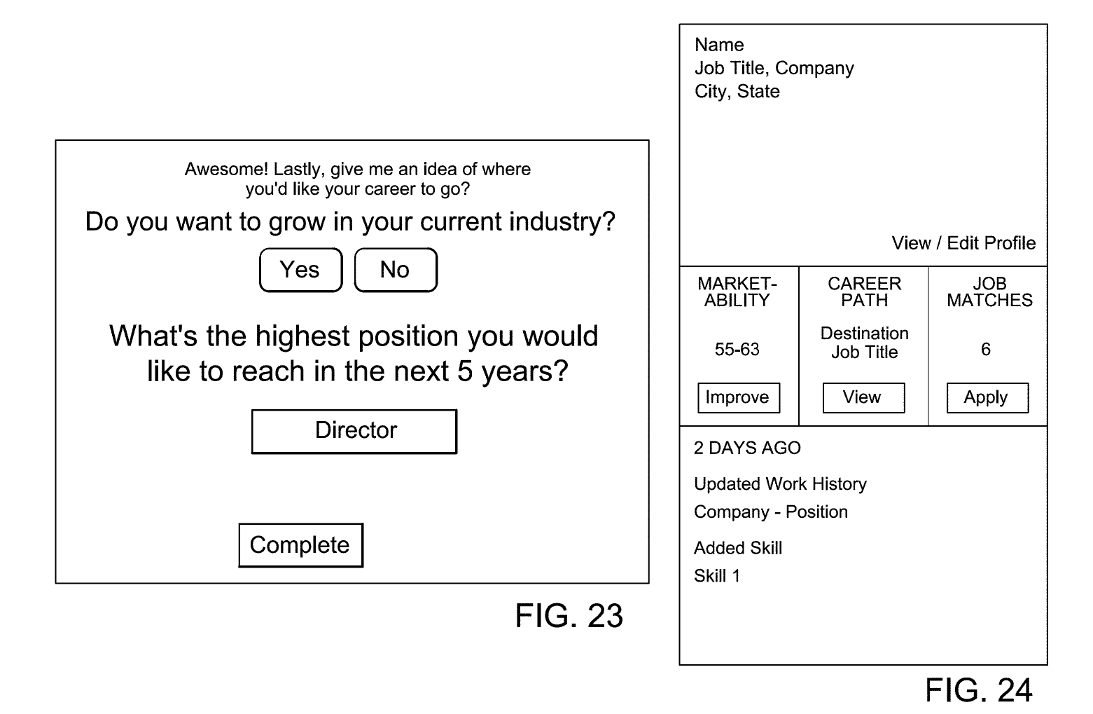

Users will be asked to enter additional information to allow the different features to analyze (and compare if applicable) the user's data to other internal/industry data. For the window shopping, only 1 option will be displayed for the users; however, the true number of results will be displayed for added impact. (e.g., 15 career paths are found to be relevant for this person based on the data they entered, however, only one career path will be displayed). This will engage the users to register and view the remaining analysis. Examples of screen for soliciting the additional information is shown in FIGS. 19-23.

Dashboard:

The system dashboard gives users an overall view into their career management. They have access to their profile, to allow them to enter additional details around their experiences, skills, education, licenses, certifications and other pertinent information. There are summaries and links to the primary features of the system. Marketability, Career Paths, Salary and Job Matches. There are also call to action items, advice, as well as other notifications around assisting users with their careers. An example system dashboard on the user device is shown in FIG. 24.

Onboarding/Import Resume:

To make the data gathering intuitive and easy for users, the system has options to onboard users into the platform. This includes importing user's resume document and parsing out the data into specific data fields. This data is used for various features within the system to give more transparency to users on their career status, and assist them with future career discoveries. Users have an option to import their resume. Users can choose to upload their resume during the onboarding to the product. They can search their local drive or other apps such as, e.g., Dropbox™, Box™, Google Drive™, etc. and select their resume. Users can only select the resume if it is in a Word, PDF or Text CV format. Users can review and edit the information that is being added and choose which information to pull into their profile. The import is performed in less than 5 seconds typically. Output fields are displayed in a user-friendly format, grouping like fields (e.g., all education fields together, all skills together).

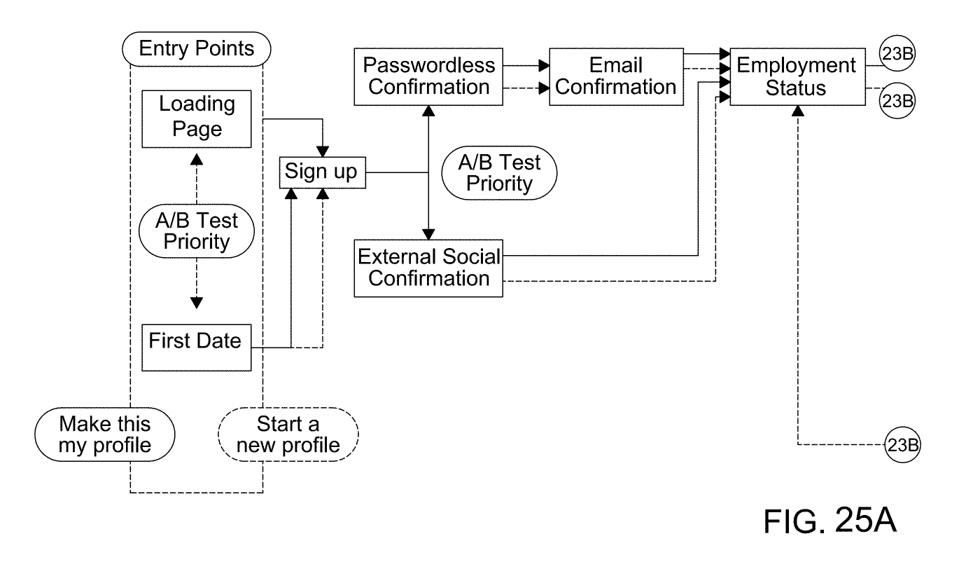

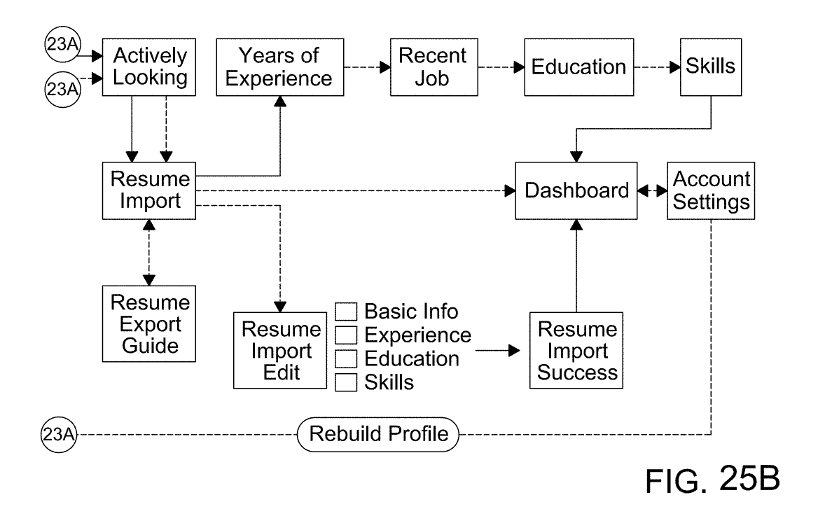

The process attempts to capture pertinent profile data, however only required fields, e.g., email address and persona questions, must be entered to proceed. Users are not asked for information that was previously entered through teasers if they chose to keep their teaser answers. The process is engaging and motivates users to continue giving information. After interaction with discovery, the user profile shows updated information based on their responses. At any time, users can drop out of the interaction and previously captured information is saved to their profile. This Onboarding/Import Resume process flow is generally illustrated in FIGS. 25A and 25B.

Profile Management:

Profile building is comprised of several ways for a candidate to input data. Users will enter some of the profile data if they went through any of the guided setup. They are asked to answer specific questions needed for the specific feature that they will route through the system to. The system will import resume and parse out data. Then users may view the imported results and edit/update.

All of the data may be manually entered via the “sections” within the profile (e.g., Name/Contact; Work Experience; Military Experience; Education; Skills; Certifications/Licenses). It is key for the users to have an easy and intuitive method to update their data. Since this is a living/breathing bio, the users will be able to update education, skills, licenses/certifications, experiences, performance results; ad hoc information (e.g., development project information/successes); performance reviews. For military, once they enter their military experience, the skills are transferred over to civilian skills. This assists with matching veterans to non-military job positions.

All data is private. The individual decides if/when to share which data points, and who to share it with. Companies or Recruiters will never have access to the users' data without their explicit authorization.

Various data points are gathered/stored in the profile, and are used for a variety of system functions, including, for example: Career Path Analysis; Marketability; Salary Comparison; and Job Recommendations.

Within the system, users have the ability to store uploaded documents (e.g., resume, certification, and license documents). These can be stored at the profile level or within each of the profile categories (e.g., Education). Users are also able to personalize their account with their picture/avatar and a recorded video. Users are able to tag items and have them as part of their profile. They can organize these items with categories. For example, they can tag a course that a person just took and store this under a “training” category; or tag a blog that they want to reference in the future and store that under “reference material.” Users are then able to share these tags with others within the system platform.

Users have access to take different assessments. These assessments will help users better understand their skills, strengths and weaknesses. Given this information, users are better positioned to strengthen weaknesses and skills. Users are able to record a short video around who they are, as their professional bio summary. This video can then be shared with companies.

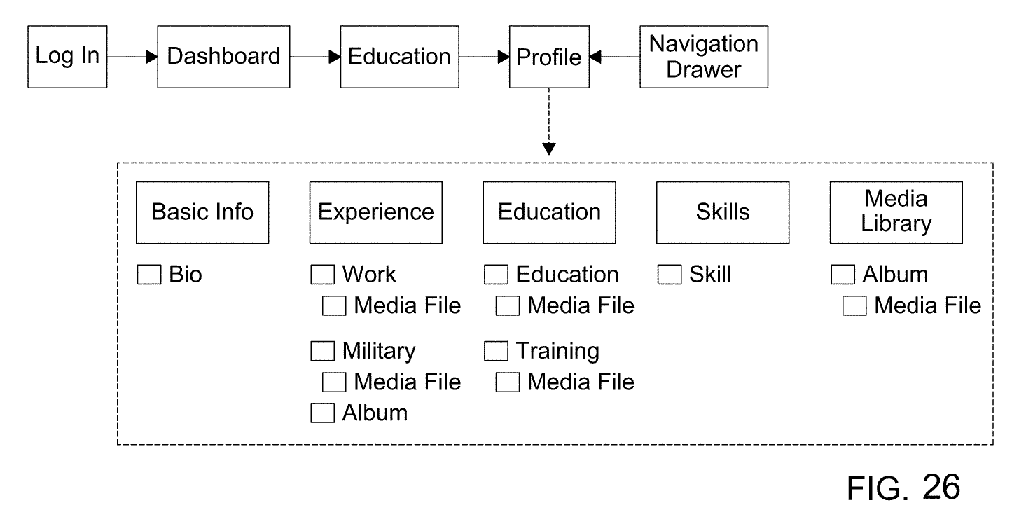

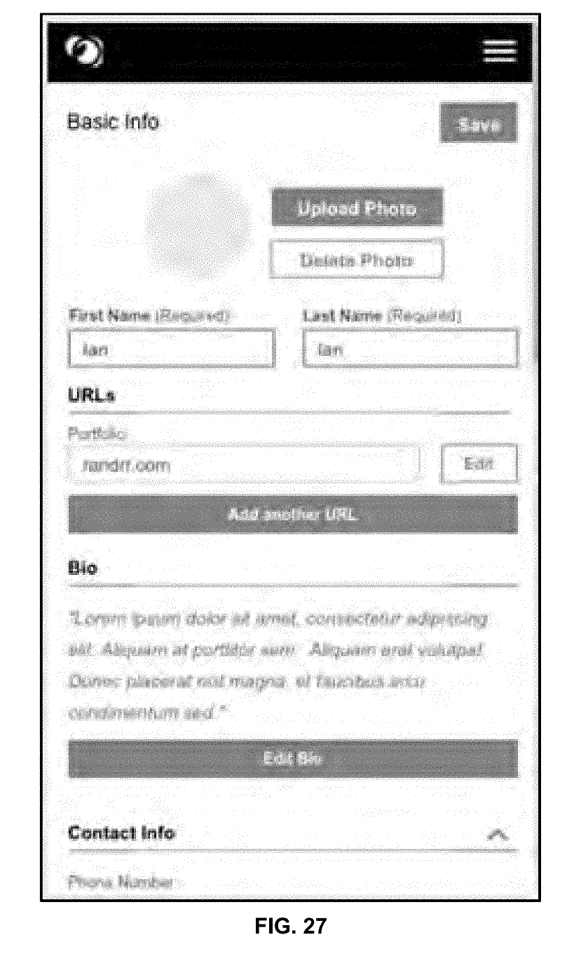

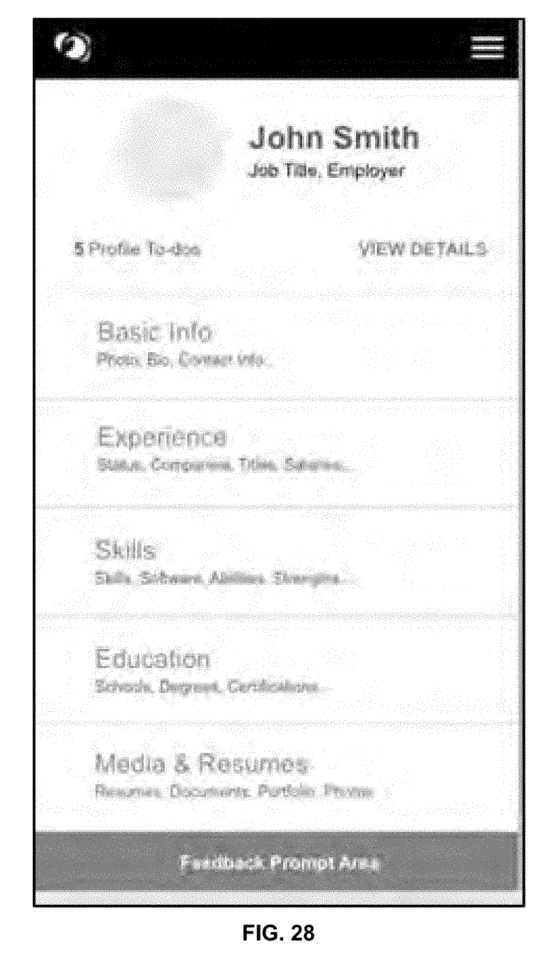

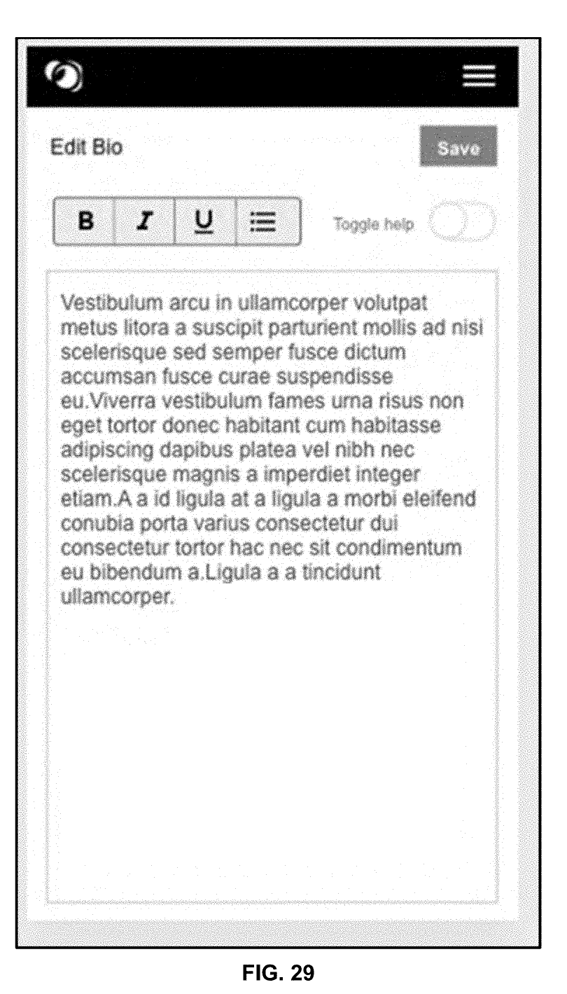

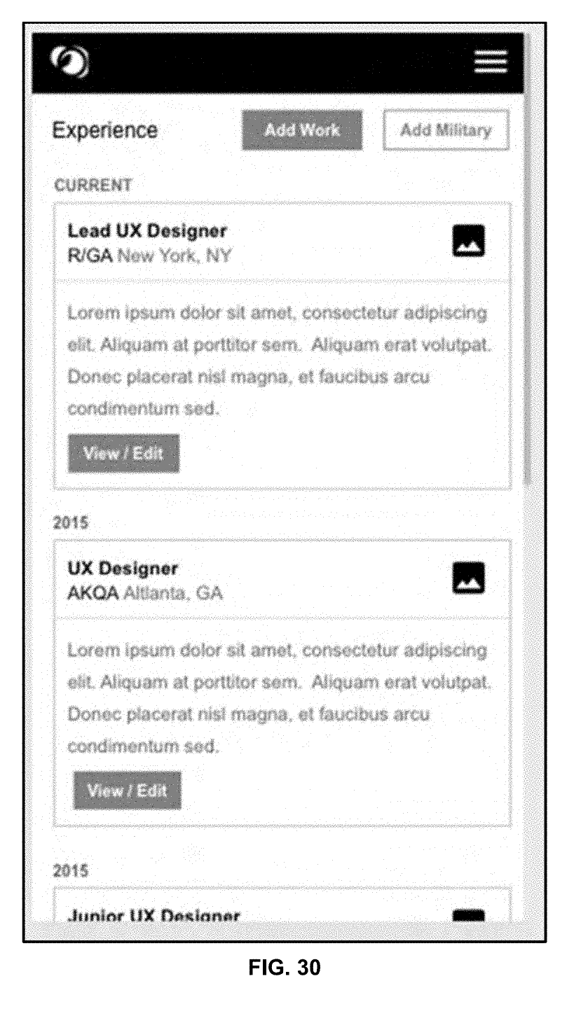

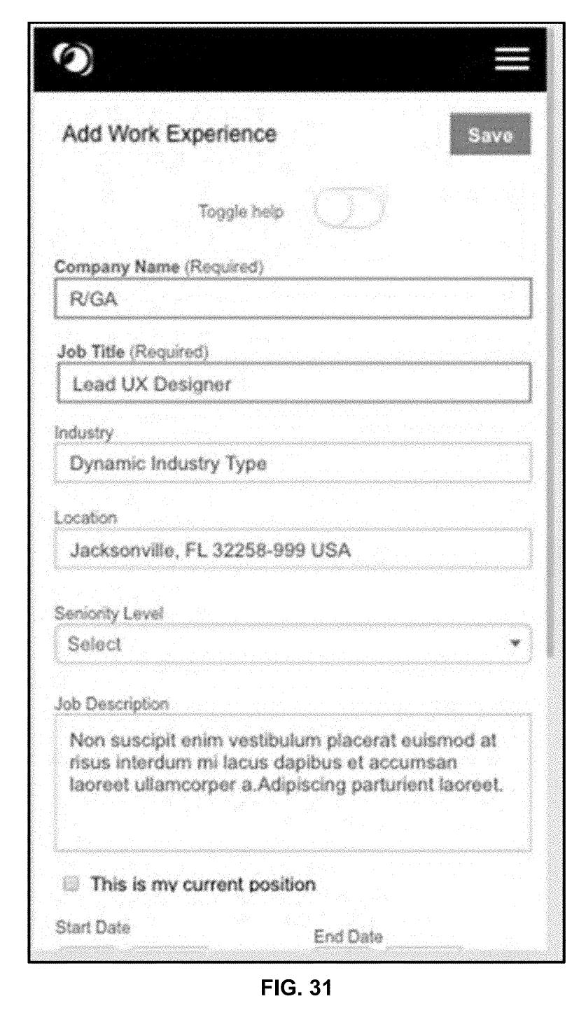

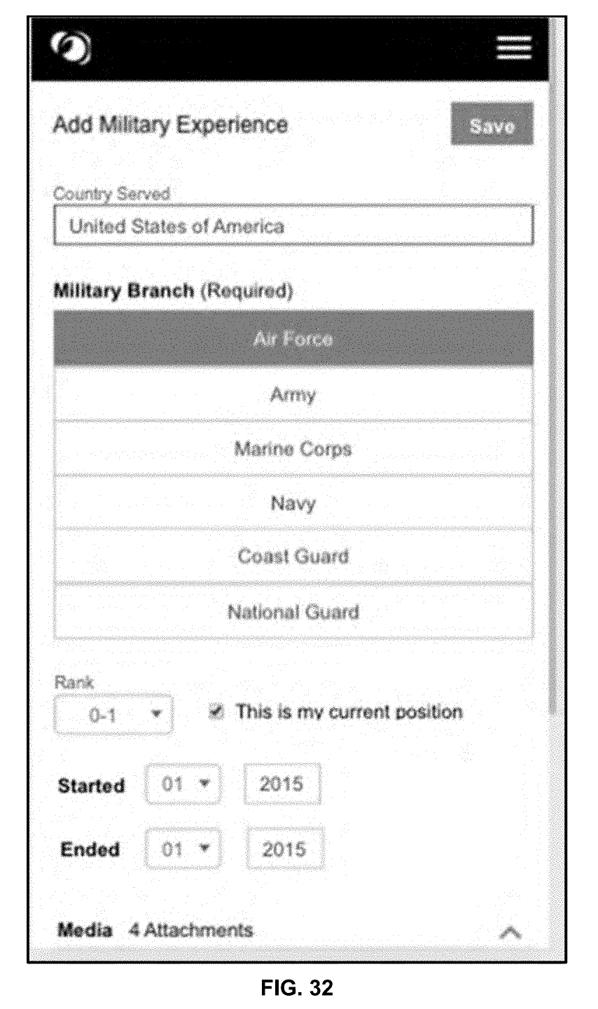

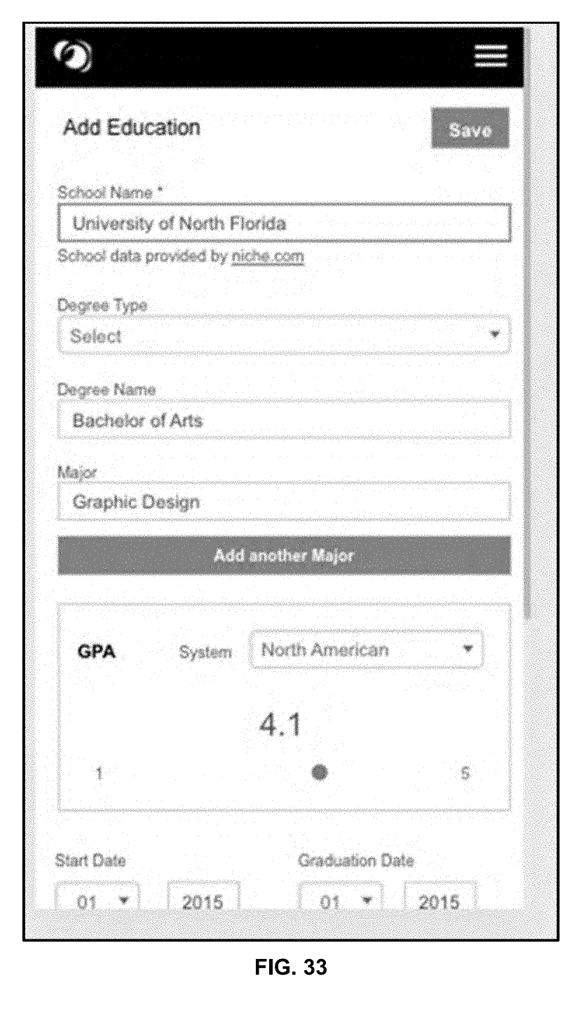

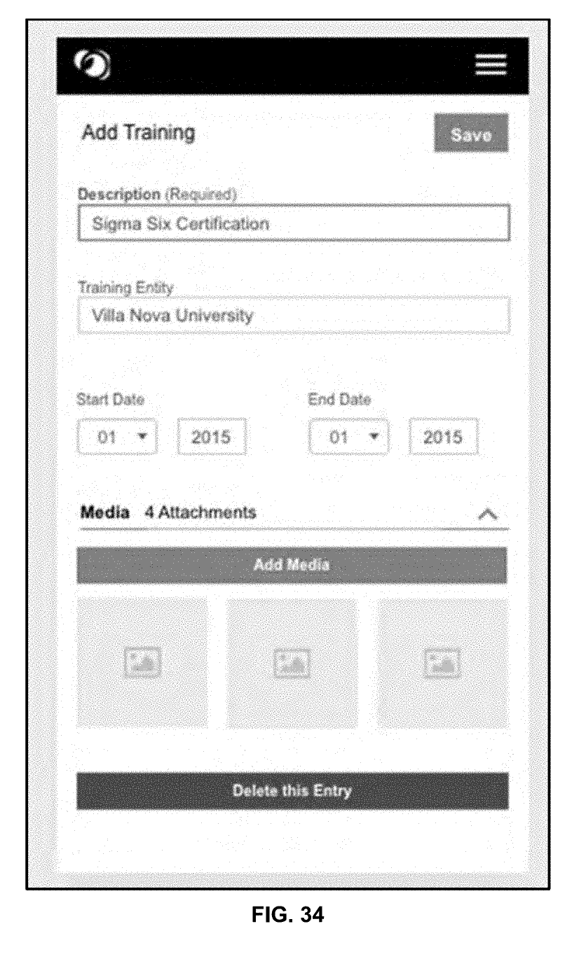

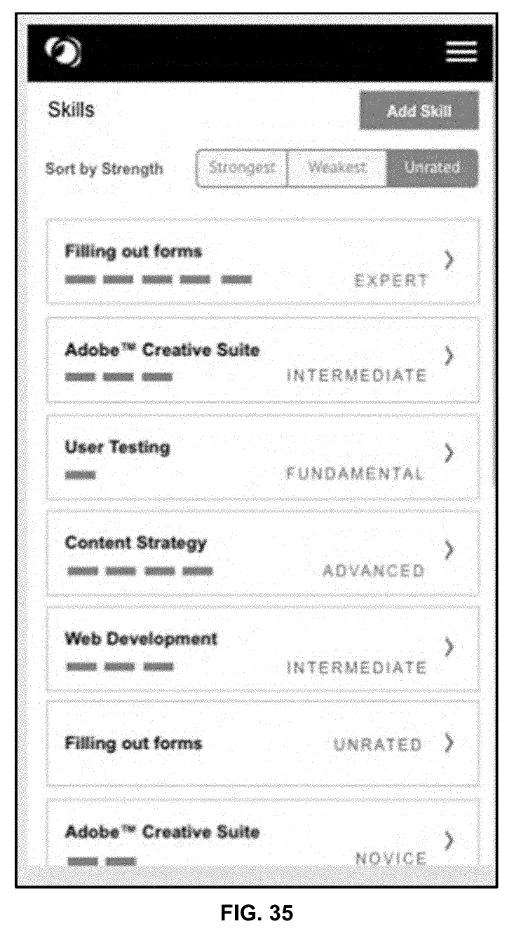

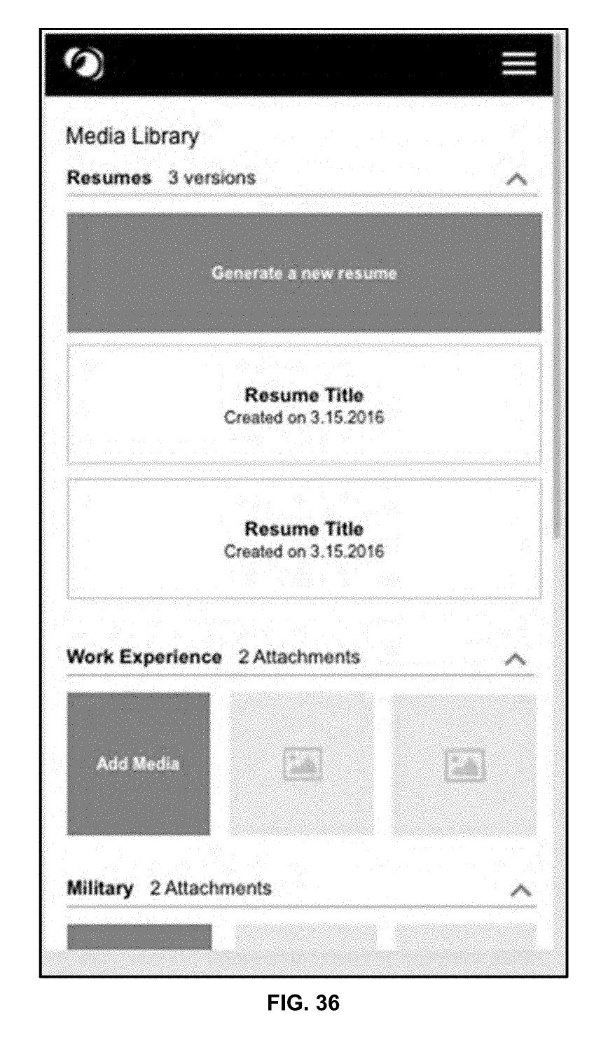

Users can indicate their Areas of Focus of most interest. This allows the system platform to tailor the user experience based on this information. Examples of Areas of Focus can include Skill Advancement, Salary Increase, Training, and Seniority. These processes and examples of user interfaces are generally illustrated in FIGS. 26-36.

Resume Builder/Export Data:

The system provides an easy interface that allow users create/save views of their resume. This includes the ability to create numerous resume “views.” Each resume can contain unique data or written in other languages. Then they can select which resume to share with other users/companies.

The ability for users to share their resume/bio with external users is also provided by the system. This could be when applying for jobs, or sending the resume document to a recruiter or company.

The system allows users to create multiple cover letters and attach to each resume view. This allows users to tailor their cover letter to the specific job for which they are applying.

The ability for users to share their resume with a company and remain anonymous is provided by the system. This is made possible when companies sign up for the system. There is an option to allow users to submit their resume anonymously to any company within the system. They can also chat with a company recruiter. Users will have full control on if/when they reveal their personal information. To create an anonymous resume, users have the option to just select “Anonymize”. The system platform will automatically remove all PII.

Users are also able to share saved media with others as well. Examples would be Licenses, Certifications, Diplomas, Published Papers, etc.

APIs through the system will allow users to share their data with others. This can be used to fill out an employment application with company Talent Acquisition Platforms or Applicant Tracking Systems. This can also be utilized for import into these platforms for background check data collection or onboarding information.

Users are able to create a digital format of their resume. This will correlate with the companies that opt in to the system platform. This digital format of a resume will include the Miranda Graph, as well as the person's holistic 3D Experience Stack. This can also contain any other data that users have in the system platform (skills, experiences, certifications/licenses, education, attached media). Users can share this resume by create a microsite. With this site, they can remain anonymous as well. This page will not be public, but can be shared via a link (link is good for 5 days).

The system offers resume review options for users. The system career coach will review the user's resume and bio summary, and provide feedback.

Career Path:

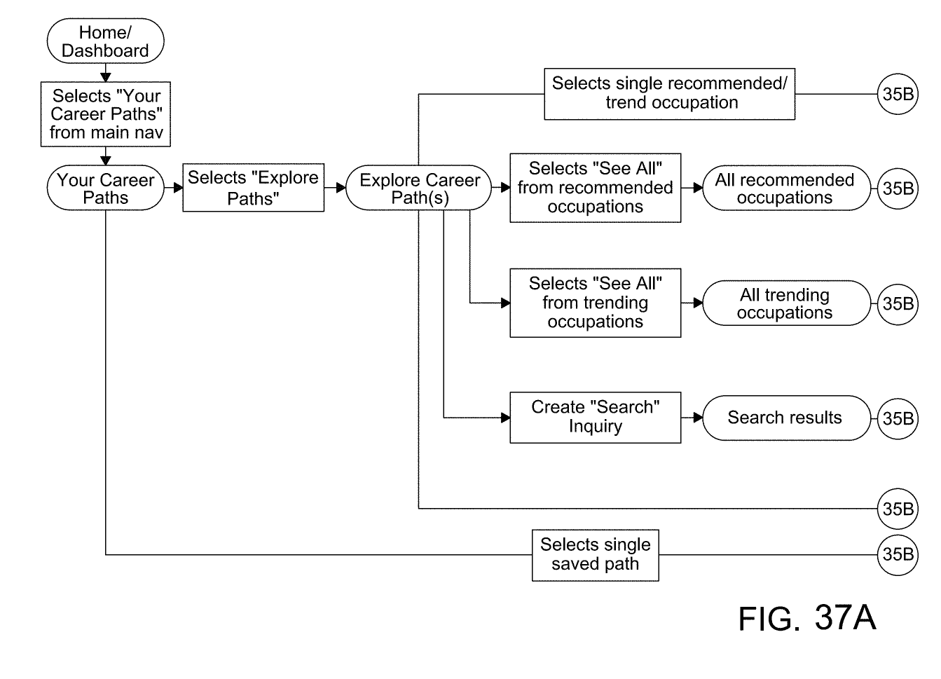

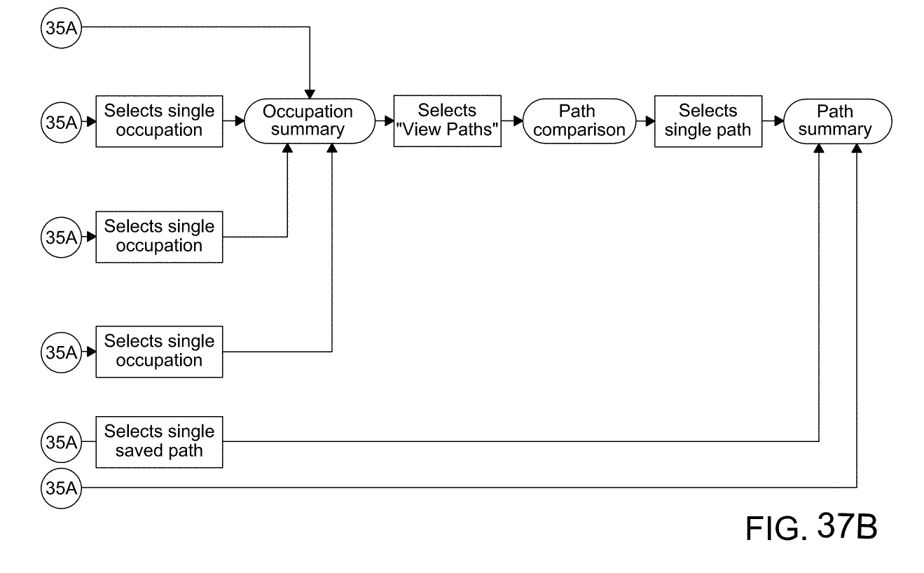

Within the system platform, users are able to discover many different Career Paths. This is for the students investigating what career they would like to invest their studies in, as well as users that are already in a career, looking at other career opportunities. Unlike other competitors in this space, the system is utilizing a unique algorithm to determine the career path options. There are two paths for users to use. A→B, users will give us their current education, skills, and many other aspects of themselves, and the system will present many career path options to users. They can then drill into each path, and save specific paths. Once saved, if any of the criteria changes for these paths, they will be notified. The other option is B→A, which is where users indicate their dream job, and the system will present the path to get there. FIGS. 37A-37B generally illustrate this process.

Career Path Teaser:

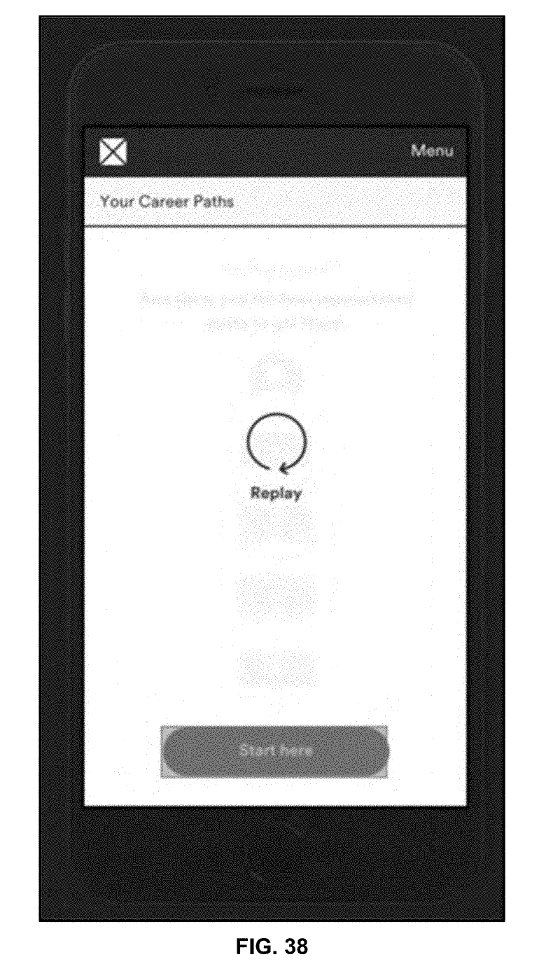

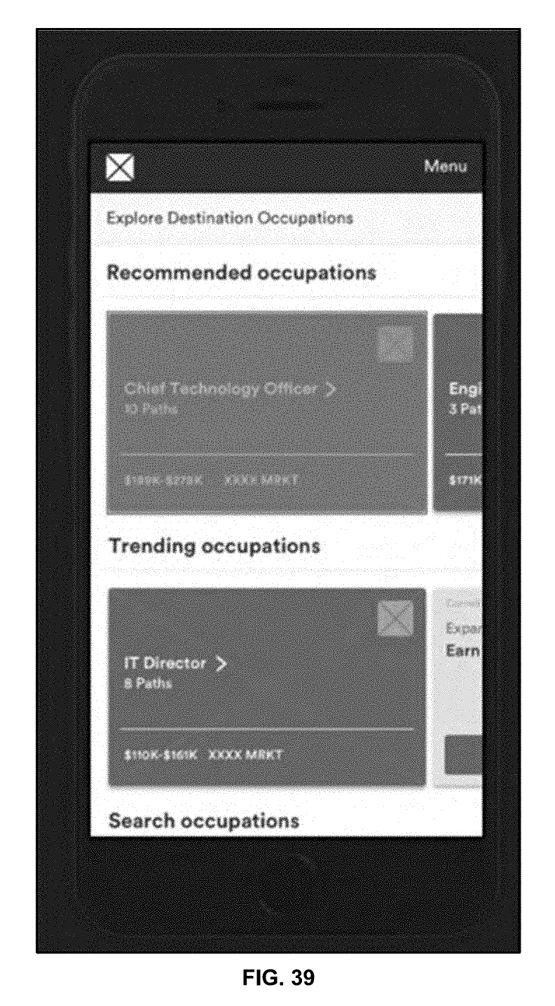

Users are shown career paths that are relevant to where they are in their career today. All but the most common path may be blurred out and requires sign-in to view. Users can select the nodes on the path to view the Occupation Summary for the selected occupation node. Users have a call to action to sign-up to see more paths or save the current path. Users have a call to action to sign-up and see more Recommended destinations or Trending destinations. The system platform will analyze current profile data and prompt users to enter more data if needed. FIGS. 38 and 39 are examples of user interfaces generated with these features.

Display (A→B) (recommended paths):

Users can choose to view the system's Recommended Occupations to possibly set as their Career Path Destination.

The occupations are sorted with the occupation with the highest probability category for the user showing first. Users can see up to 5 career occupation options, their pool of occupations are static unless they make changes to their profile that impact the recommendations. However, the display will randomly select from their overall pool of recommended occupations on each visit. If No recommended occupations are available an alert will notify them to ensure that their profile data is up-to-date. Users will have a link that directs them to the missing or minimal data that is impacting the lack of recommendations (e.g., if the user has no or minimal work experience in their profile, the user will be requested to please update so that additional recommendations can be found).

Users can choose to view the system's Recommended Occupations to possibly set as their Career Path Destination. The occupations are sorted with the occupation with the highest probability category for users showing first. Users can see up to 5 career occupation options, their pool of occupations are static unless they make changes to their profile that impact the recommendations. However, the display will randomly select from their overall pool of recommended occupations on each visit. If No recommended occupations are available an alert will notify users to ensure that their profile data is up-to-date. Users will have a link that directs them to the missing or minimal data that is impacting the lack of recommendations (e.g., if the user has no or minimal work experience in their profile, the user will be requested to please update so that additional recommendations can be found).

Display for A→B and B→A:

As users type in their search criteria, the system uses autocomplete to show matching Job Titles or Industries. Users can select an occupation to use as their career path destination occupation. Alternatively, users can select an Industry to see a list of occupations within that Industry. Occupations by Industry will display the same information as Recommended Occupations. The occupations are sorted alphabetically. There is no limit on number of occupations shown. Users can select an occupation and view the Occupation Summary for this occupation. Users can exit the search without selecting a career path destination occupation.

Trending Occupations:

The occupations are sorted by highest trending first Nationally. Users can see up to 5 occupations, this list may change randomly if there are more than 5 trending occupations in this occupation pool for a single occupation. Users can exit trending occupations without selecting an occupation as their career path destination. Users can select a trending occupation to use as their career path destination occupation.

Overview of Options:

Once users have chosen to access the Career Path tool, if users have previously saved paths, users are taken directly to their saved paths to view their paths or users can Explore other paths if desired. If Exploring paths, users have an option to either search for a known Destination Occupation or users can view recommended destination occupations or trending occupations. If searching for an occupation, users can enter partial text and options are populated for them based on matches against text entered only. Users can view a summary of an occupation to evaluate if this is their preferred destination. Once users set an Occupation as their Career Path Destination, users are shown a comparison of common paths to their career destination. From path comparison, users can select a single Path to view a summary of the selected path. Users can save one or more paths of interest to them for ease of access to the path later and the system notifications that drive them to that path. When users save a path they can define if users want to receive notifications/alerts for this path. Users can return and explore different Occupations to view paths for a different Destination. Users can save paths with different Career Path Destinations.

Occupation Summary:

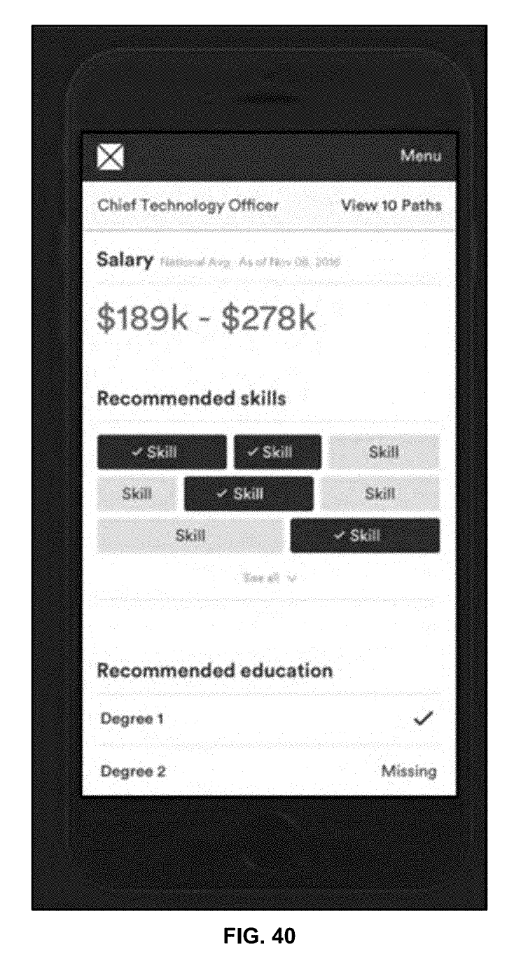

Users may choose to view the summary of an Occupation for consideration as their career destination. Skills that users do not have are highlighted as gaps. Most commonly required skills are given the most importance. Required Degrees that users do not have are highlighted as gaps. On each review of this occupation, all gaps will be evaluated based on user's current profile. Users have a call to action to view Job Listings for the selected Occupation using their Job Preferences. Users have a call to action to view and compare paths to the selected Destination. Users can go back to explore more Occupations without setting a career path. FIG. 40 generally illustrates a user interface showing an occupation summary.

Path Comparison:

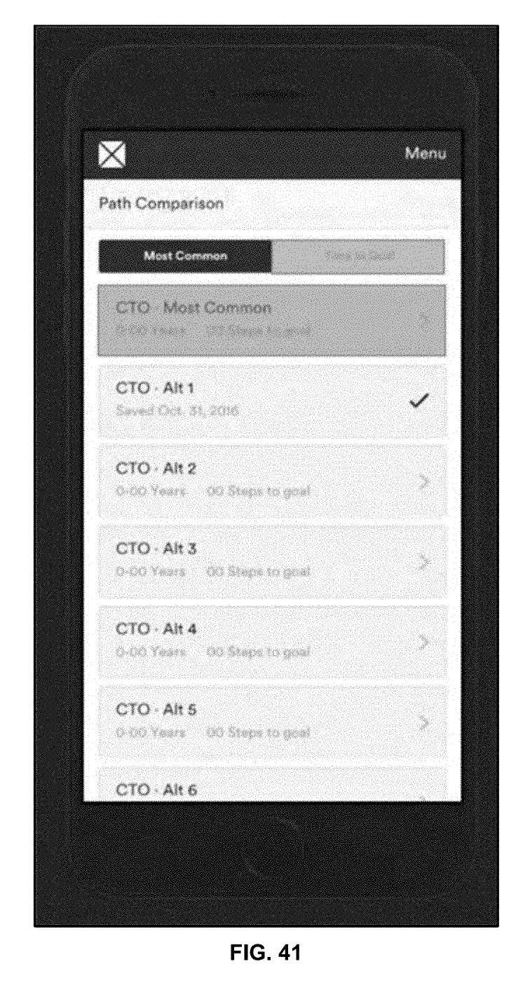

Users may choose to view paths for a selected Destination Occupation. The paths shown represent the most common paths from their current career state (Education, Skills and Work Experience) to the selected destination occupation. Users have the option to view the Paths ordered by commonality with most common path first. Users can also view the path by Time in Years to reach the destination from their current state. If users are a student the first occupation node is based on their education only. If users are not a student and are not employed, the first occupation node is based on their previous job title. If users are not a student and are employed, the first occupation node is based on their current job title. The names of the paths are generated by the system and users cannot change them (The most common path is labeled ““Job Title” Most Common” and then ““Job Title” Alternate 1”, ““Job Title” Alternate 2”, etc.). There is a minimum X Paths and a Maximum of Y Paths ordered by the most common paths for their career destination occupation. The Most Common Path is indicated as such on the screen. Previously Saved Paths that are represented in a new Path Comparison for the same destination occupation should have an indicator that it is already a Saved Path. Users can select a single Path to view its Path Summary. Users cannot delete or hide paths. Users can return and view more destination occupations to view paths for a different Destination Occupation. FIG. 41 generally illustrates a user interface showing a path comparison.

Path Summary:

User may either choose to view the summary of a path from the Path

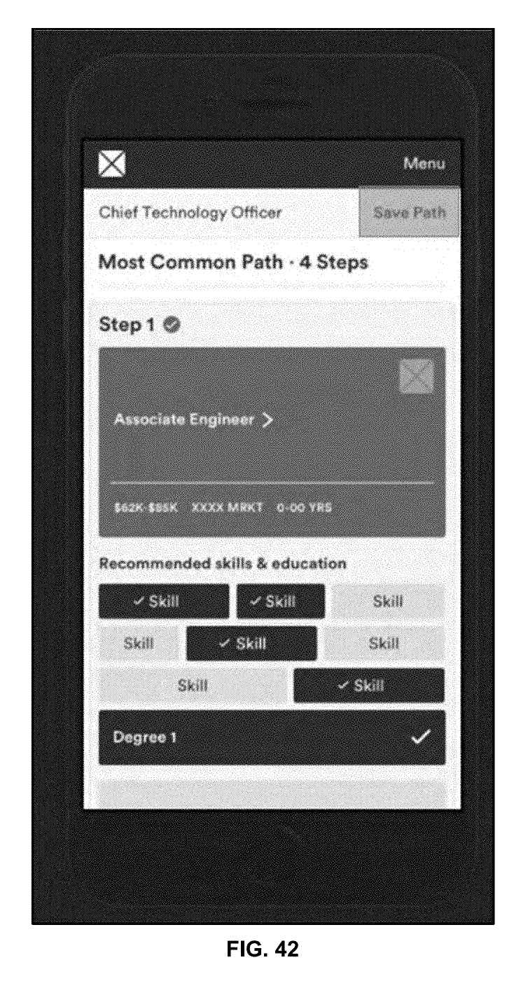

Comparison or from a Saved Path. Users can select an occupation node and view the Occupation Summary for the selected occupation node. Occupation Nodes start with user's next job, current jobs do not show within the path. Users can mark that they have acquired a required skill. User's Skill gaps to an occupation node are based on existence of skill only, not proficiency of skill. Users cannot edit a path's nodes, e.g., change the selected occupation along the way. Users can save the current path so that they can later view the path from their list of Saved Paths. When saving a path, users can designate if they wish to receive notifications on changes related to this path, default should be to Yes. When path is saved the current date is stored as Saved on date. Users can save up to 50 paths with the same or different career destination occupations. Path name is stored as a system generated name and is not editable. The path starts with users next node (step), (current node/occupation is not viewed on the path). If the user is a student and they do not have an occupation the path begins with their highest level of education, the saved path starts with their next node (step) from their current education. The skill gaps and marketability for each Node should be re-evaluated against a user's current profile anytime they access the Path. If users mark that they acquired a skill that is shared across more than one node, the skill is marked as acquired within all related nodes for this path. When searching or exploring paths users cannot delete or hide the paths. Users can delete their saved paths via Saved Paths. Users can exit the career path summary without saving this career path. FIG. 42 generally illustrates a user interface showing a path summary.

Update Skills:

Users can choose to update their skills for a particular Occupation from within their Career Path. Users can denote that they have acquired a skill that is marked as Required for this Occupation. If this skill is required for other occupations within a Saved Career Path, the state of those skills are updated as well. Any skill users mark as being acquired within career pathing is displayed as a new skill in their Profile skill record. Users can return to the Path Summary.

Saved Paths:

In some cases, users have saved a Career Path and have an option to view a list of their saved paths. The Paths are sorted by Relevancy and Recency, most relevant first and if no relevancy, most recently saved first. Users can see up to 3 saved career paths with the ability to see more if additional paths have been saved. For each path users can see the Saved on date representing the date they saved the path, for this week these dates should be represented as; Today, Yesterday, Day of Week for day 3-7. The occupation nodes for user's saved paths remain static from the day it was saved; no changes to recommended nodes within the path are shown. The skill gaps and marketability for each node will re-evaluated against user's current profile anytime they access a Saved Path.

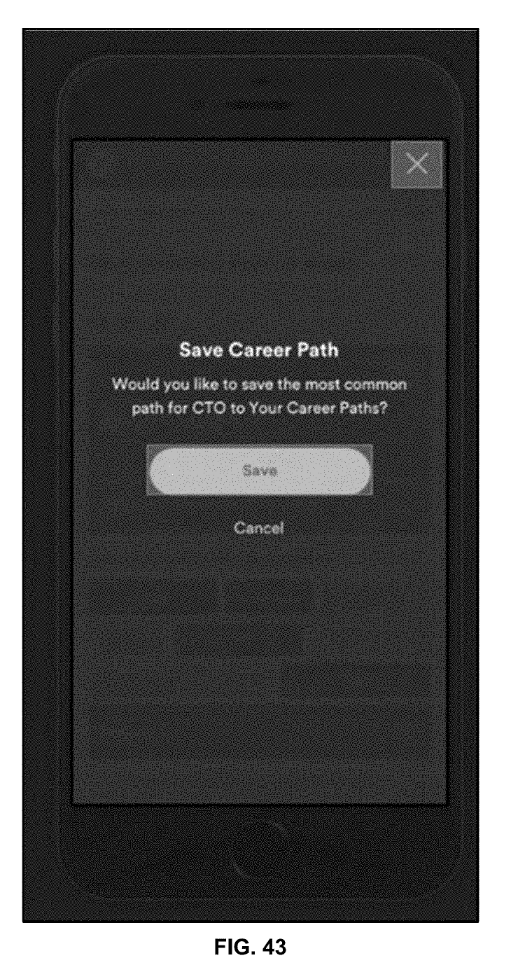

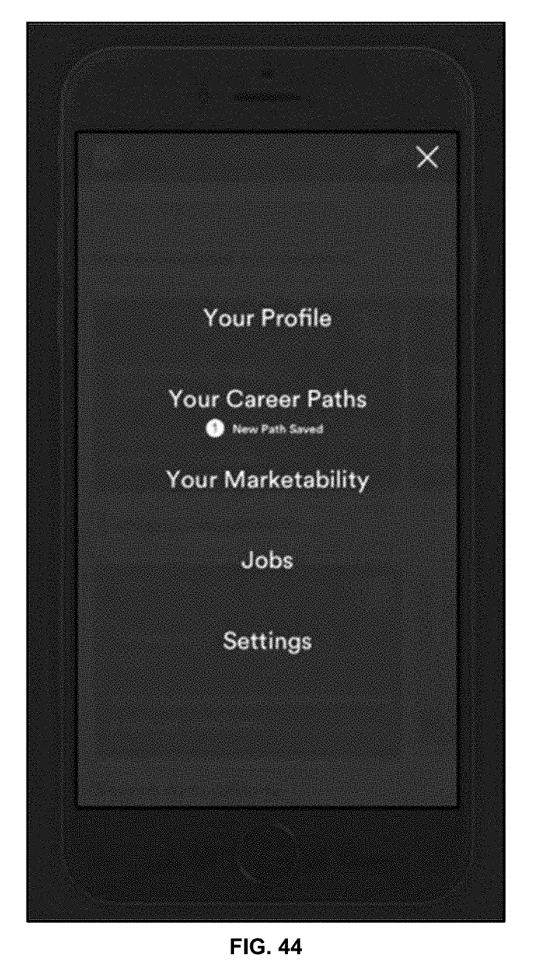

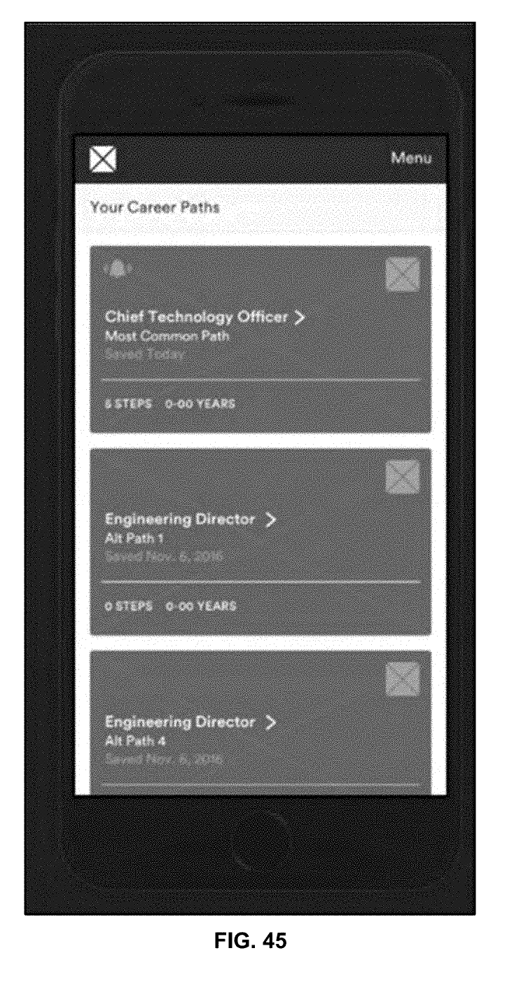

Any progress users make that is relative to a saved path will be updated on the path. If they go off the path (take a job unrelated to the saved path) there will be an indicator that they are not currently on this path. The path will remain saved until they choose to delete it. Progress updates to the path will still occur, if they happen until the path is deleted. If users want to find a new path to this destination from their current occupation, they can go to Path Comparison to explore different paths. Users can delete a saved path. Users can easily turn notifications on and off for all paths. If a Path is deleted it no longer shows as a saved path but may still be a recommended or alternate path. Users have an option delete multiple paths at one time. Users can choose to view the Path Summary for a saved path to see current state of the path. Users can exit without viewing or deleting a path. Users can choose to explore other paths and return to Path Comparison. FIGS. 43-45 generally illustrate a user interface showing saved paths.

Notifications:

An alert notification may be displayed on My Dashboard until users view the alert. There is a call to action within the alert to view the impact of the notification.

Other Features:

Users can view path options by Most Common Path; Shortest Path; and Highest Earning Path. Also, the most impactful skills and education are highlighted. The system platform will display Salary Trends and Job Demand Trends. Related Job Occupation Titles will be presented as well. For students utilizing the Career Path, Schools/Institutions are given a Score on their student job placement in that field of study. When skills/education gaps are shown, the system offers a Learning Marketplace for users to investigate professional development: online courses, education, tutorials, articles, books, blogs, etc. A Career Heat Map is available for users to view Open Jobs, Companies and Salaries (if available) giving users a geographical view. The system also has the capability to evaluate user's growth patterns, and predict future skillsets that are the best fit based on defined interests. There is an option to compare users skills against others that have added additional skills and Notify users if that Add x skills than could move into XYZ role.

Top Influencer Career Path Clone:

The system may include completed profiles from top influencers. Then users can select one of these top influencers, and discover the career paths that were taken.

Career Path Algorithm:

The purpose of the career path algorithm is to provide the common and most successful paths from a user's current position to a destination position (destination is either self-selected of explored through recommendations). All users job position titles in their work history are assigned an O*Net category. If users position matches a more granular cluster within the O*Net category, they will be assigned that occupational category (as described above in marketability).

All users job position transitions (transition defined as movement from one job to the next) are stored in the system using graph database with the time between each transition. Resume position transitions are created and recalculated every X days (to be predetermined) in the system based on the platform's user database.

Based on the existing database of transitions, Yen's algorithm (as one nonlimiting method) and other suitable statistical methods including graph theory methods will be calculated across all users to calculate the probabilities of transitions between each job position. When a Career Path Destination is chosen by a user, the paths with the strongest probabilities of transition from the user's current position and selected destination is presented. When no destination is selected, transitions from their current position with the highest probabilities are displayed under recommended paths

Job Management:

Job recommendations is where the system is really disrupting the hiring industry. Instead of users applying to every job that they find, the system will match user's skills, education, certifications, licenses, experience and return the best matches for job recommendations. This will stop the “chatter” in the industry. Providing a User's Platform that unifies job recommendations will greatly reduce the effort for users, as well as for the companies. Therefore, users that find jobs via the system will save recruiters a lot of time. The propensity will be for users to only apply to jobs where they are best qualified. The other side will mean that users will be less frustrated with the job application process.

Users also have the option to search for any jobs utilizing preferences if they opt to. This will allow them to receive new job postings for specific job titles, locations, compensation preferences as well as many other preference settings.

Due to the intuitive nature of the system platform, users will see jobs where they are a good match. This is based on user's' skills, experience, education, certifications, and licenses. Then using the system proprietary algorithms, users are presented with job openings displaying their Job Qualification Score.

All of these the system features interact with one another. Users are guided from one feature to another and given advice along the way. This also distinguished the system from other companies.

There are also social aspects to the system product. Users are able to communicate with others and remain anonymous.

Dashboard/Flow:

There are 4 categories displayed to a user, namely: 1) Saved Jobs (if applicable); 2) Recommended Jobs; 3) New Jobs for You; and 4) Emerging Jobs. As one example, 15-20 open job postings will be presented in each category, with an option to “show more.” All jobs will be posted with the highest qualified jobs at the top of the list. Users can sort jobs by Salary High to Low, Newest to Oldest Job Postings, and Oldest to Newest Job Postings.

Job Listings:

Job listings will include: 1) Job Title; 2) Company; 3) Location; 4) Job Type (e.g.: Full Time); and 5) Qualification Score. As a Job Recommendation Teaser, users will be asked to answer a few questions and input their top skills. Based on that information, the system's proprietary algorithm will present job recommendations. Users will be able to drill down into the top qualifying job match. After this, they will be asked to create a login for additional information.

Job Recommendations based on user's profile data:

Using the system's proprietary algorithm, they will be presented with recommended job postings.

Job Search:

This feature allows users to search open job postings in a free-form search box. The job presented are filtered based on the user's defined preferences, namely: 1) Job Title; 2) Job Category; 3) Location; 4) Company; and 5) Preferences. Job Search Preferences will allow users to store their preferences, which will be remembered for the next search. Preferences may include: a) Job Qualification Score; b) Skills; c) Job Title; d) Industry; e) Company; f) Job Type; g) Location; h) Commute Time; and i) With none of these words.

Users are able to save jobs that they are interested in. Notifications alert users to additional matches to their saved searches. Advice will be given to users based on the results shown. Users may not be marketable for any of the job openings. This might be that they are looking for jobs where they do not have all of the requirements/skills needed. Therefore, the system platform will direct them to the Marketability feature to better discover the best current job title fit, and then Career Path to plan their future goals.

The system also offers users a view into job openings via a Geographical Map. This allows users to browse other locations where jobs that they are searching or recommended jobs are located. The map offers views of open job positions based on recommended jobs, jobs searched (with preferences), new jobs and emerging jobs.

Users are able to communicate with companies that have opted in to the system platform in an easier and more intuitive method. They can chat or submit a resume (or digital alternative resume) anonymously. Again, users have full control on who and when they share any of their data.

As users prepare for their interviews with companies, they can click on a company link, which will present them with the company's corporate site, social sites and any recent news. This will facilitate users with researching a company and being more prepared for the interview.

Users that have worked at a company will be able to give feedback which will be shared with other users in the system platform. This feedback can be given anonymously. Only allowing users that have worked or are currently employed with a company to give feedback better validates their input.

Users can also click on any company to pull additional information about that company. Links are to the Company Corporate website, social sites and recent news about the company.

Users are also notified when a job that they have saved has been removed from the job posting list.

Users are able to share jobs with other users, send to their social site as a posting or email to other users.

When users' preference is a specific company, they are given other companies within that industry to select for a preference as well.

Users are able to opt-in to a Company Talent Community via the system. This applies only to companies that have joined the system platform. Users are able to opt-in with their email address or anonymously. Companies will then send branded campaigns to users about their organizations.

Users will have one central location in the system to view all of the jobs that they have applied to, current status, company, and any additional calls to action. This applies only to jobs where the company has opted to use the system's Workflow Feature.

Users are able to set preferences based on company culture or employee offerings. (e.g.: lifestyle benefits—work from home; health benefits—Medical Insurance; Career Benefits—Training). This not only helps users match to companies where these things have a high importance to them, but it also helps companies. Organizations need users that will be a cultural fit which helps with a lengthy retention.

Users are able to complete a One Stop Apply. This Candidate process is simplified for all jobs where the company has opted-in to the system Workflow Feature.

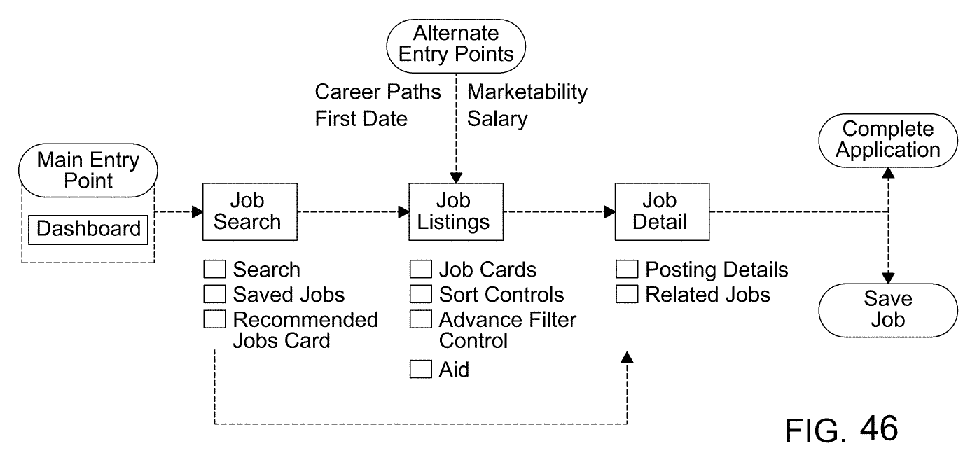

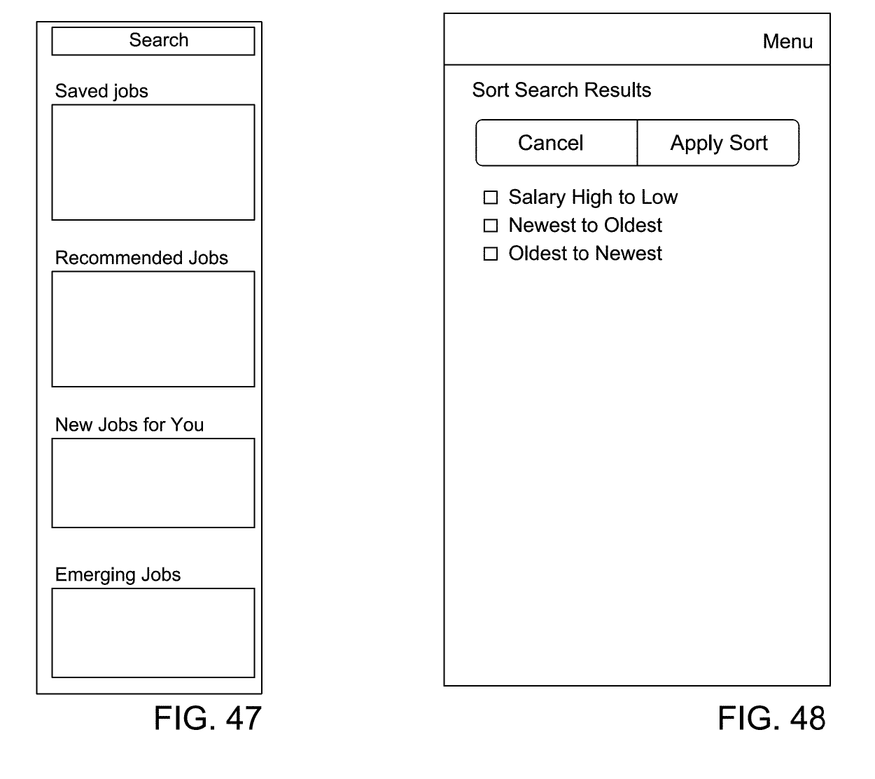

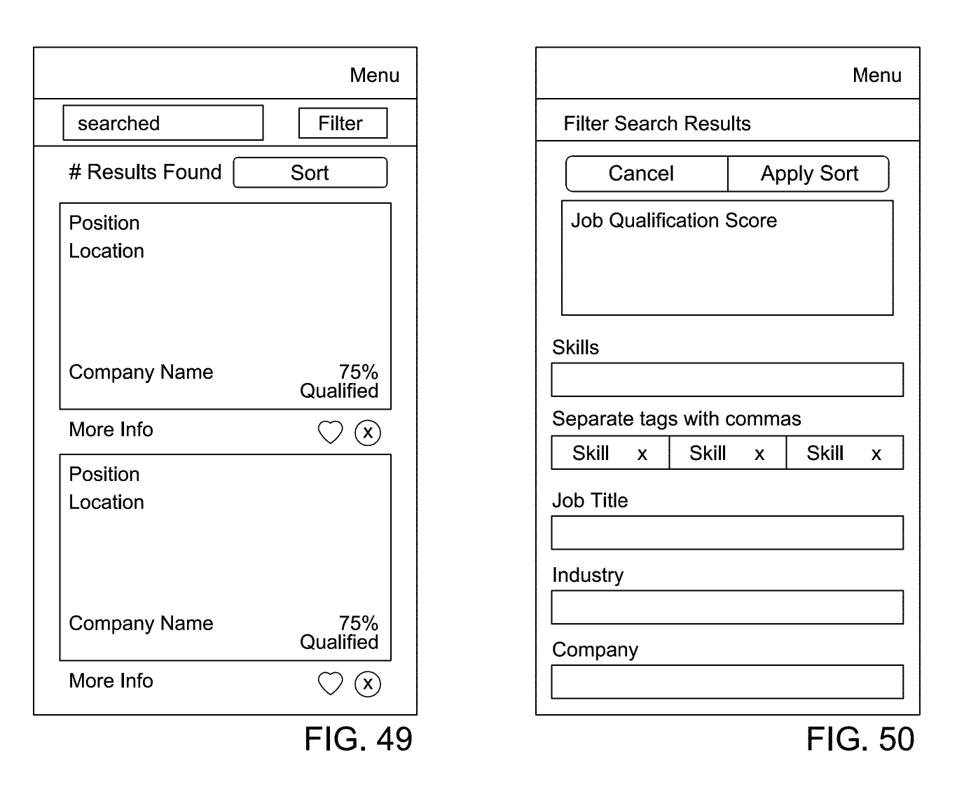

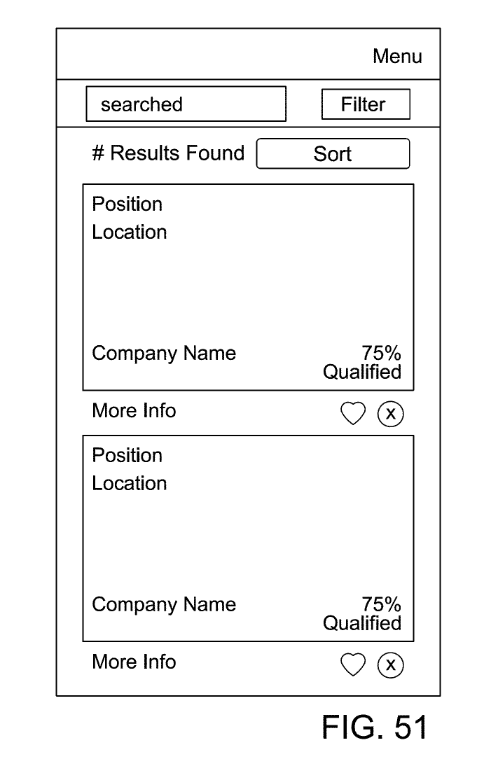

Users are able to have references attached to their profile. These can be sent to the references by the user, and the reference can complete the document. Then users are able to utilize these references for job applications as needed. Reference letter can also be attached to users' the system profile. A process diagram further showing the job search function is depicted in FIG. 46, and illustrative of user interfaces associated with the job search function are shown in FIGS. 47-51.

Marketability:

The Marketability feature is where the system is unique as well. The algorithm to calculate user's marketability takes numerous data points into the analysis.

Users need to know how marketable they are in certain industries, job markets and locations. This gives them the view into knowing if there are gaps in their skills, and if so, what those skills are. It's also good for users to know what locations they might be more marketable. Knowing the needed skills or specific locations to be competitive is key to success for these users.

The system offers the preparation of a complimentary marketability assessment for registered users of the system platform. The system's professional analysis includes: a) a realistic “market value” range based on comparable salaries of other professionals with similar experience, role, and skills; b) a list of positions that you qualify for and potentially new career path options based on transferable skills; and c) assessment of gaps in skills and/or experience required to increase desired marketability.

Users need to know how marketable they are in certain industries, job markets and locations. This gives them the view into knowing if there are gaps in their skills, and if so, what those skills are. It's also good for users to know what locations they might be more marketable. Knowing the needed skills or specific locations to be competitive is key to success for these users.

Input:

Input may include Most Recent Occupation Group (current job title mapped to O*Net to determine Occupation Group). For students: i) Comparison Group by degree of study; ii) GPA; and iii) Skills/Certifications.

Home Page Display:

The home page display may show a Marketability Category (determine score, and translate to an Occupation Category). These category names can be selected as desired. A user click into the Detailed Marketability Page, and can view: 1) IMPROVE YOUR MARKETABILITY/Personalized recommendations for new skills, education, licenses and certifications needed to make the person more marketable as compared to your PEER GROUP; 2) Job Title (determines O*Net Occupation Category); 3) Display top Drivers (Skills/Education/Certifications) and highlight Gaps, namely: Skills (capturing skill proficiency), Education/Certifications, GPA (Students), National vs. top 10 metropolitan areas (this can be location specific if data is available), TEASER: Only National; Everything else is greyed out, Marketability available for National and each of these metropolitan areas, Ability to click on metropolitan area to search for jobs, Recommended Jobs based on their Qualification Score for that location, and Search recommended jobs with missing skills.

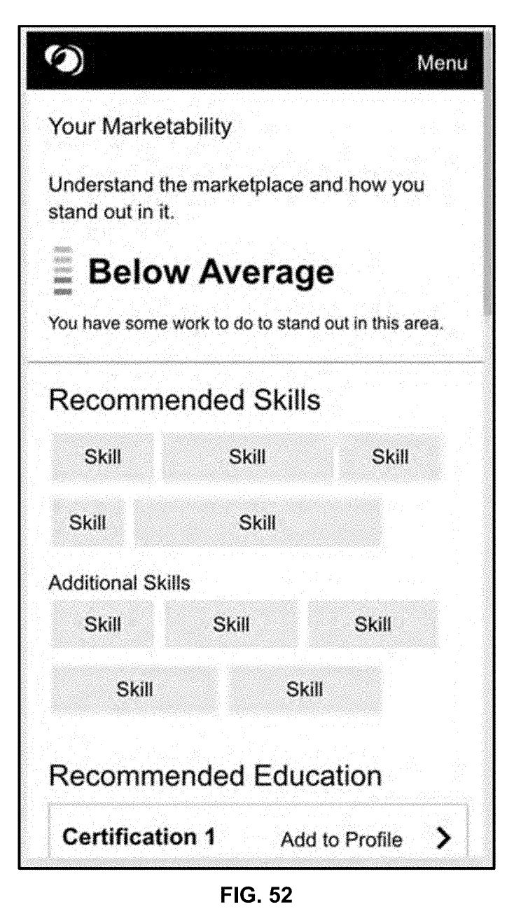

A user's marketability will be displayed throughout the system application, outside of the Marketability tool itself. For example, the user interface may display: 1) User's Dashboard—user's current marketability rating (bucket) based on most recent occupation; 2) Lateral Job Recommendations within their Occupation Category (Students—Education comparison category), CTA—search for jobs recommendations; 3) LINK TO CAREER PATH, Marketability to Occupation Nodes/Occupation Destination; and 4) Identify emerging skill trends within jobs—new skills that need to be added for the Marketability Assessment/Category. This is part of the skills weighting. Call out new skills needed. This means that the system has to track the current skills to be able to identify if a skill is new. FIG. 52 generally illustrates a user interface showing marketability.

Algorithm: Marketability Description

The purpose of the algorithm is to understand how qualified (“marketable”) a user is based on their self-reported work experience and skills for a specific occupation category. Users' resume or profile is classified to their most relevant O*Net occupation code. All Job postings are assigned an O*Net Occupation classification. To attain further job granularity, Job postings are clustered within their O*Net segment using, as a nonlimiting example, k-means clustering (or other statistical clustering methods) to group similar job descriptions.

Within each specific job or occupation cluster, the frequency of required and preferred skills is calculated using TF-IDF (term frequency—inverse document frequency). Weights are assigned to skills based on frequency and importance derived from the TF-IDF analysis. Other requirements may also be extracted and weighted (years of experience, certifications, education requirements, etc.). The presence of skills and other important job requirements from a user's resume or profile are compared to the relevant job posting cluster extracted weights to calculate their “score”—example: (0.50)skilla+(0.21)skillb+(0.05)skillc=Score.

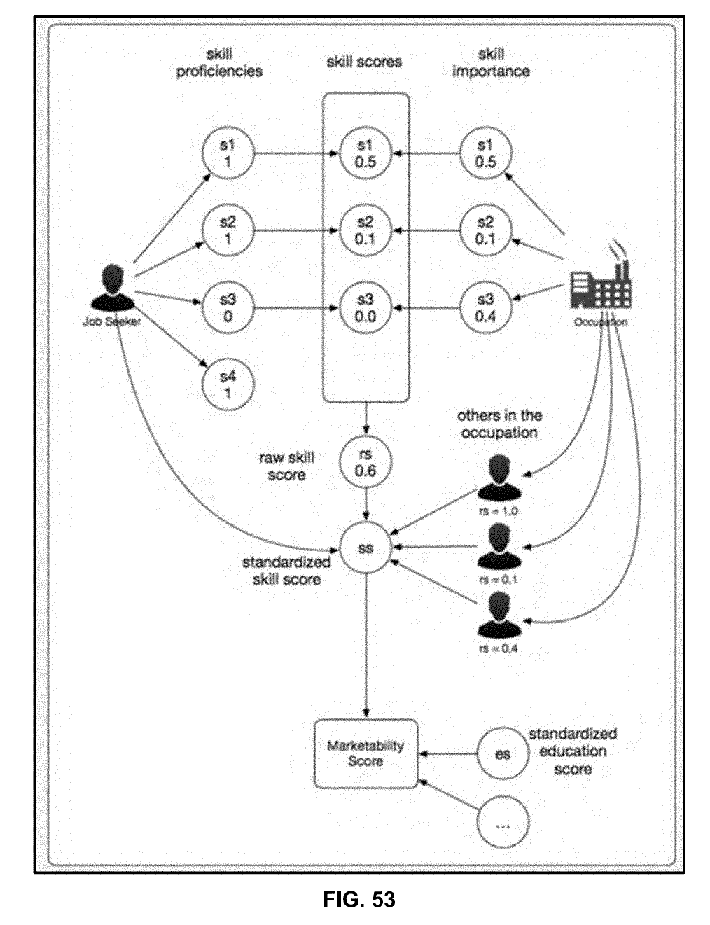

Users in each cluster are ranked by score. Score ranges are mapped to an ordinal range with an associated label that will be displayed to user that is yet to be defined (example: high, medium, low); alternate versions may show a numeric score on a scale of 0-100. For general marketability—user is compared to the job cluster they currently belong in. For Career Pathing—user is compared to job cluster in each node of the selected career path. FIG. 53 is a schematic diagram generally showing one algorithm for generating the marketability score.

Salary Comparison:

This is another feature within the system platform. Users can view if their salary is competitive relative to their job title and other aspects. The more details that users enter into the system, the more accurate the salary comparison is. Advice is given depending on the salary comparison gap. If the gap is medium-high, the users will be given advice around asking for a raise, or transitioned to the system marketability to determine if they are marketable against their peers.

Resources such as Salary.com™ may be used to provide the salary data. The system allows users to enter their current job title, base salary and location (city, state, country, zip) and give the salary comparison based on that data (pre-populate the information if available in profile). The system also allows users to explore with different job titles and geographic locations (users may be planning a move or just willing to go for a higher salary).

The system shows users salaries for jobs related to their current job title (many times, job titles overlap so related job title salaries could be very relevant to the user). Users are given links with specific metrics to other features (career paths/job postings) where they have the potential to make more money. Users are also given an indication of other regional markets where they have the potential to make more money. Users will be able to view Salary Trends for a specific job occupation. If a specific location is set, then the information would be relevant to that location. Otherwise, this would display a national average trend. They are also able to view Salary trends by industry. When looking at a salary, that is just part of the compensation for employees. the system offers a view into the cost of living for specific locations, as well as a benefit calculator.

Link to Other System Features:

Users have the ability to link directly from Salary Comparison to Career Path feature to see destinations with a probability score above the standard “recommended” career path probability score where they have the potential to make more money in the next node.

Users are able to follow a link from the Salary Comparison feature to the Job Postings feature to see the system Recommended Jobs (based on their profile) where they have the potential to make more money so that they can assess a possible job move.

Company:

Companies will have access to the system. They will never have direct access to user's profile/resume data unless the individual user chooses to reveal it. That said, the present platform provides a medium through which they will be able to interact with users while they are looking for career opportunities. This gives companies more visibility with users looking for employment, or just wanting to find out more about organizations. This also provides a more intuitive and streamlined process for companies and users to interact.

Account:

Companies are able to create an account, and present insights and subjective details about their organization. This allows the system product to leverage these details to better match users to a company's open job positions. With companies giving details around their industry, company size, culture and benefits (lifestyle, career and health), users will be able to have transparency into which companies are the best match to their desires and preferences.

Company Users:

Companies are able to setup company users that need access to the system. There are specific levels of permissions, depending on the user's role within the organization; for instance, Hiring Managers, Recruiters, HR Business Partners, Administrators, etc.

Company Branded Web Page:

Companies are able to create a company branded webpage within the system platform. This assists companies with showing candidates the company value proposition for working with them. This is critical for companies to be able to hire the best and most compatible talent. Companies are able to design their own page, including everything that makes them a great place to work. Companies are able to post information and tag it. the system serves it up at the right time based on those tags and motivation within the system. The system controls the experience and puts their information in front of the right person at the right time, including: 1) Industry insights; 2) Contributions that the company is making to the industry as it relates to what that person is engaged in their experience stack; 3) Insights from the functional team that the person is exploring; 4) Tips and tricks of the trade; 5) Benefits offered; 6) Culture; 7) Job Openings; and 8) Job/Career Fairs.

Web pages are SEO friendly, which will give companies more exposure. Users are able to initiate contact to connect via chat with company recruiters. They can either expose their identity, or remain anonymous. They can then ask questions around the company and job openings.

Job Postings:

Companies want to hire the best talent. The system product will assist companies in making a great impression on potential candidates. Since the system will have the critical mass of users within the platform, companies will want to leverage this partnership. Companies will be able to showcase their value proposition to users—like lifestyle, career, financial and health benefits offered. As for users looking for employment, this will allow them to review and search on company cultures and company attributes; an overview of all company locations, and available jobs. They will also be able to opt-in to a company Talent Community (e.g., anonymously) and chat with a recruiter.

While the system is able to pull all open jobs in the US and present these to the system users, the format sometimes is not in the desired format. The system platform allows companies to post their own jobs, directly in the system platform in the customized format that they prefer.

Templates are available to companies to set up job type templates, thus making the job posting entry simplified. With these templates, companies can select from various fields, making these required, read-only, optional for the company user.

The system also offers an API for companies to electronically send open job postings, remove job postings, and edit current job postings. The system employs third party aggregators and scrapes from company websites and job boards to facilitate companies posting jobs to the system platform.

Company Advertising:

Companies are able to create advertisements. These are displayed to the system platform users. With the system having the critical mass of users in the platform, this gives companies an opportunity to brand their organization with employee prospects. There are many different levels of advertising available to companies, depending on the number of times they want the ad placed in front of users. The system also will target users that are in the same industry as the company, or those that have expressed interest in the company.

Company Alternate Resume Review:

The system is replacing the outdated resume and CV with a much more comprehensive tool. This allows recruiters to find the best talent for a specific job opening. This also removes all of the bias in the hiring process.

Miranda Diagram/Graph:

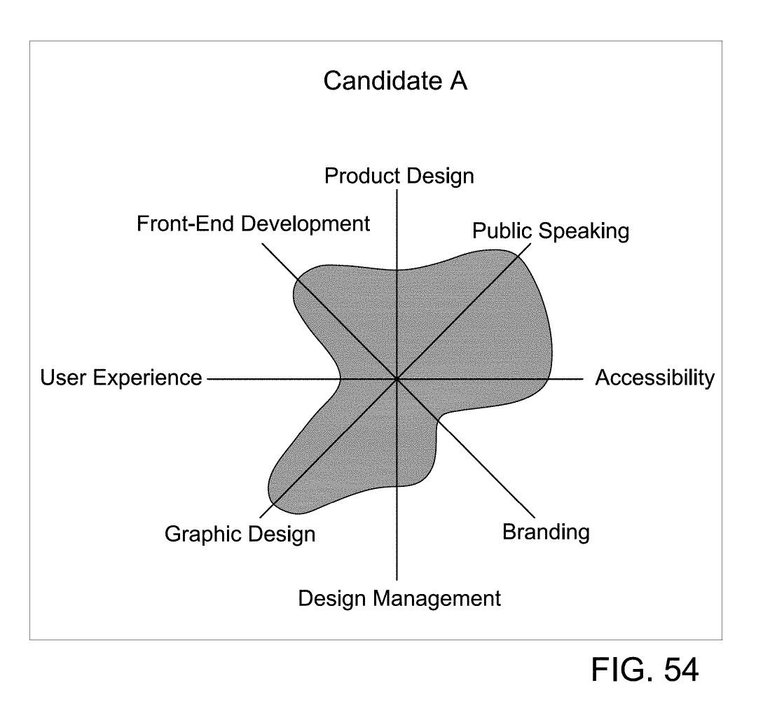

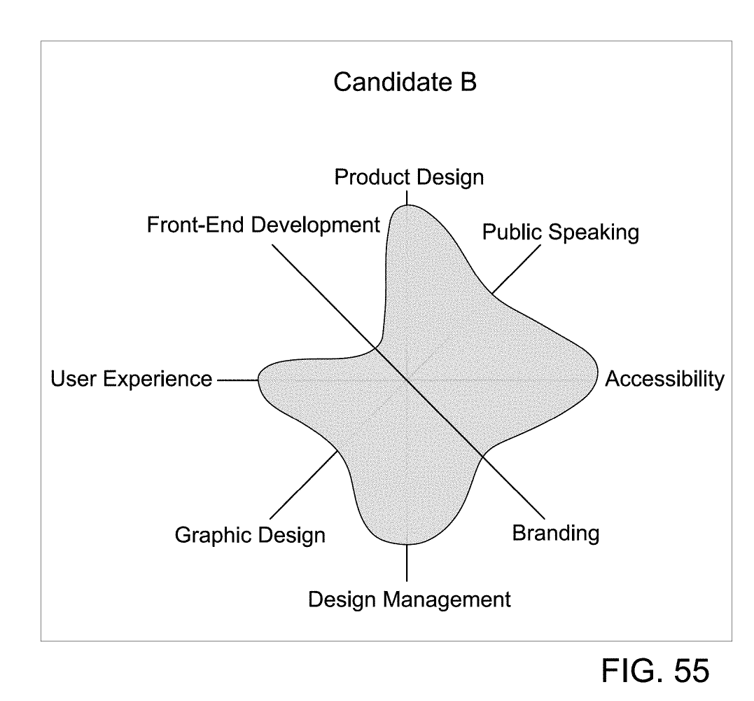

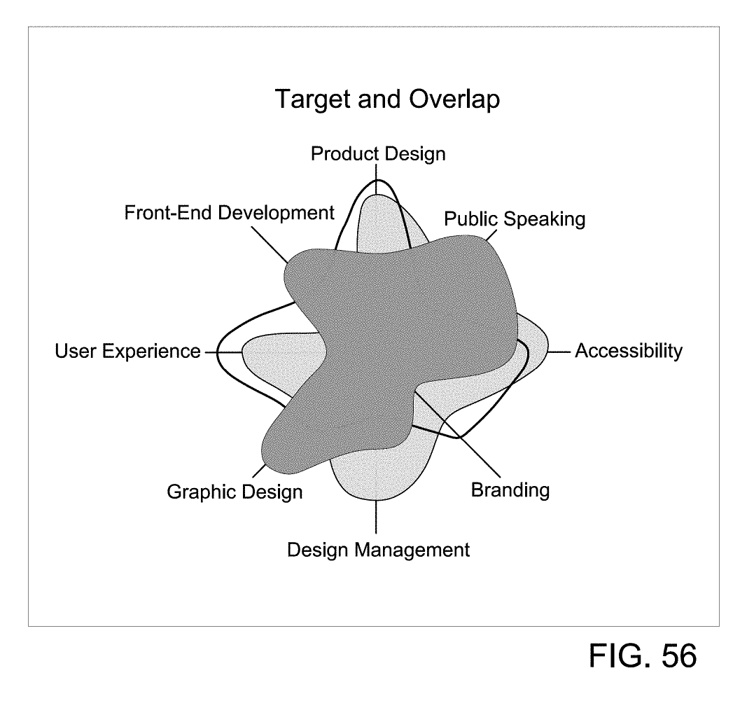

Companies identify key requirements to a job opening. This includes skills, experience, education, culture, etc. Based on user's profile data, a comparable graph is created. Companies can then view the overlap version when comparing the job opening to users. This is a very fast and effective way to find the best fit candidate. FIGS. 54-56 depict examples of Miranda diagrams/graphs according to the present disclosure.

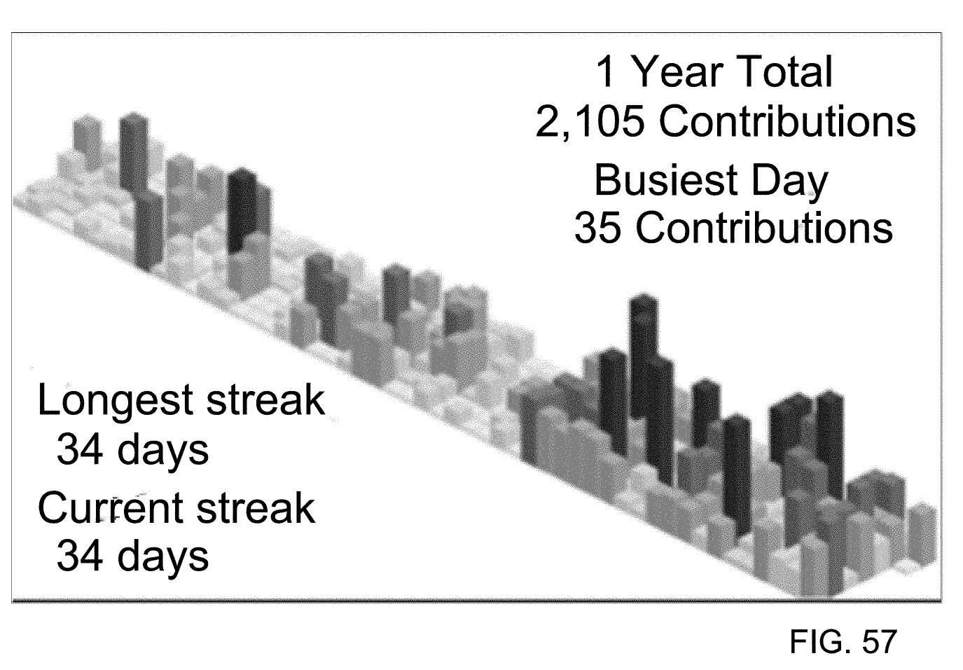

There are also other graphs to allow companies a holistic view of users. This is a 3D Experience Stack interactive tool to drill down into specifics for each item. This includes: 1) Experiences/Military—years; 2) Skills—proficiency; 3) Education/Training—Year completed; 4) Certifications/Licenses—Year; 5) Publications/Awards—Year; 6) Personal Achievements/Community Service/Other—Year. FIG. 57 depicts an example of a 3D experience stack graph according to the present disclosure.

Company Career Growth Tracker:

Companies can give all of the occupation job titles with the necessary skills and other requirements. These can then be used by the company employees that have opted-in to the system platform so that they can discover career paths within a specific organization.

Workflow Tool/ATS:

The system platform is offering a workflow tool that will allow users to better interact with companies. The current application process is very frustrating for users. They have to continually enter the same data with every company that they apply to. Companies that leverage the system's workflow tool will be giving users a much easier and confidential way to express interest in an open job, apply to the job, and proceed through the entire hiring process. Since the system stores user's profile information, there is no need for them to duplicate these entries. As a candidate proceeds through the hiring process, and additional data is needed, they just need to “accept” and the data will be passed to the appropriate company at the appropriate time. The platform is fully mobile for both users interested in jobs and companies working through the hiring workflow.

Candidate value propositions with the present system may include: a) Less repetitive data entry; b) Bio Summary/Video; c) Alternative Resume; d) Recorded Interview; e) Employment Application; f) Background Check data points; g) Onboarding data points; h) A more streamlined process; i) Faster hiring process; and j) Full transparency into where candidates are at in the hiring process. In fact, users are able to view the number of users that have applied, and the number of users being interviewed.

Company value propositions with the present system may include: a) Better job matching to the best talent; b) Faster and easier method for identifying the best match with the alternative resume, Miranda Graph and 3D Experience Stack; c) Removes the bias and subjectiveness from the candidate review; d) Much faster hiring process with the recorded interview, and data feeding directly from a candidate profile. No more waiting for users to come back into an ATS and submit the requested data; e) Fully compliant workflow tool; f) Configurable to meet any of the hiring workflows. Hourly, Exempt, Interns, Temporary, etc.; g) Easy and intuitive tools to move candidates through the hiring process, (profile review; pre-screens; interviews, interview feedback/candidate scorecards; background integrations, onboarding, and hiring); h) The system platform removes the burden from the recruiter/Hiring manager with full status updates provided to users real-time. ; i) Marketplace with APS for assessment vendors; background company's; drug screening companies; Federal/State forms vendors, 1-9 vendor, as well as others); j) User Advice; and k) Notifications.

User Social:

Users are able to interact with companies and other users within the system platform. This includes: a) Personal connections with others in your circle; b) Mentoring opportunities; c) Users can share job opportunities within their circle.

Advantages and Unique Features:

The system has features and benefits that are not offered by any other company. The system offers users the following:

I) The ability to remain anonymous. Users can decide if they want to share their data, what data is shared, when and with whom the data is shared. This is unique in the industry. It blocks the chatter from recruiters spamming users about job opportunities (which users may or may not be a good fit or want). It also allows users to find out more about job opportunities before exposing their personal information.

II) Career path tools—The system gives users the tools to see what their career path would be with their current set of skills and earned skills. Today when job seekers apply for a job they are not offered advice, they just apply for jobs they think they are qualified in and hope for the best. The system will give them tools to find jobs they are interested in and qualified for.

III) Marketability features—No other company is giving job seekers the ability to see how marketable they are. The system will show users how they rank in their area based on their skills and experience and give them a sense of where they fall in the market. The system will also give them tips on how to improve their score. This keeps users from getting so discouraged with the job search process. They only apply to jobs where they are highly marketable—with a greater opportunity for success. This also allows users to stop the other side of the chatter in the job application process. No longer do they need to apply to 200 job openings—but rather just to the jobs where they are marketable.

IV) Application tips—Applications can be tricky, so the system will provide tips for filling out an application successfully.

V) Salary comparison tools—Salary is extremely important and companies are getting more competitive each year. The system offers a tool that gives users the ability to see what others in their area are making in the same position and with the same experiences so they can negotiate with employers to get a fair salary.

VI) Company profiles—Some job boards offer company profiles, but the system allows companies to brand their profile, and give them a tool to connect with job seekers so they do not have to use a recruiter.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A predictive modeling system, comprising:
at least one application services server having a marketability service module and a career path service module, the at least one application services server including a processor and a memory on which process-executable instructions are embodied, the at least one application services server in communication via the Internet with at least one user device, the at least one application services server generating a single page application for viewing on the at least one user device, the marketability services module configured to generate a marketability score for provision to the user on the single page application upon receiving a request from the user device, and the career path service module configured to provide a career path to the user on the single page application upon received a request from the user device;
at least one application database stored on a memory, including a job market statistics database in which a plurality of marketability scores are stored, and a career paths database in which a plurality of career path transitions are stored, the job market statistics database in communication with the marketability service module, and the career paths database in communication with the career path services module;
a data lake receiving parsed and classified jobs data from a jobs ingress pipeline, the data lake including at least one memory having a jobs postings database in which the parsed and classified jobs data is stored, a resumes database in which parsed and classified resume data is stored, an enriched jobs posting database, and an enriched resumes database; and
a batch computing platform in intermittent communication with the at least one application database and the data lake, the batch computing platform including at least one processor and a memory on which process-executable instructions are embodied, the batch computing platform including a job posting enrichment module, a resume enrichment module, a job market analyzer module, and a career path analyzer module, the job posting enrichment module receiving the parsed and classified jobs data from the jobs posting database and computing enriched jobs data and writing the enriched jobs data to the enriched jobs posting database, the resume enrichment module receiving the parsed and classified resumes data from the resumes database and computing enriched resumes jobs data and writing the enriched resumes job data to the enriched resumes database, the job market analyzer module configured to receive the enriched jobs postings data and the enriched resumes data and supply jobs market statistics data to the job market statistics database, and the career path analyzer configured to receive the enriched resumes data and supply career paths data to the career paths database.

2. The predictive modeling system of claim 1, wherein the marketability score for the user viewing a specific occupation on the user device is generated by the marketability service module based on the job markets statistics data and the saved scores in the job market statistics database.

3. The predictive modeling system of claim 2, wherein the marketability service module receives inputs including the specific occupation of interest being viewed by the user on the user device.

4. The predictive modeling system of claim 3, wherein the marketability service module determines a raw skill score for the user, and a raw degree score for the user.

5. The predictive modeling system of claim 4, wherein the marketability service module calculates a modified z-score for a skill component of the user, and calculates a modified z-score for a degree component of the user.

6. The predictive modeling system of claim 5, wherein the marketability service module multiplies each modified z-score times a predetermined component weight to provided weighted scores.

7. The predictive modeling system of claim 6, wherein the marketability service module sums the weighted scores to yield the marketability score for the user, wherein the marketability score is a number.

8. The predictive modeling system of claim 7, wherein the marketability service module further fits the marketability score for the user to one of a plurality of buckets based on the range the marketability score falls into, with the buckets identified as developing, fair, intermediate, above average, and desirable, the buckets providing the user with an efficient indication of the user's marketability relative to the specific occupation of interest.

9. The predictive modeling system of claim 1, wherein the career path analyzer module receives inputs including a pool of parsed and enriched resumes based on an occupation taxonomy from the data lake, and user profile from a profiles database of the at least one application database.

10. The predictive modeling system of claim 9, wherein the career path analyzer module extracts transitions for each item in the pool, and classifies each employment position to an occupation in the occupation taxonomy, extracts all occupation transitions (n-grams), and keeps all bigrams and trigrams.

11. The predictive modeling system of claim 10, wherein the career path analyzer module aggregates the occupation transitions, calculates a number of times a specific set of transitions are observed, calculates an average time between each of the transitions, and calculates continuation/precedence probability for each of the transitions.

12. The predictive modeling system of claim 11, wherein the career path analyzer module finds usable transitions by filtering out transitions with a low overall sample count, filtering out transitions with a low continuation or precedence probability, only keeping transitions with a predetermined occupation maturity gain, and filtering out transitions that contain loops.

13. The predictive modeling system of claim 12, wherein the career path analyzer module combines transitions to form the career paths data.

14. The predictive modeling system of claim 13, wherein the career path analyzer module combines the transitions by overlapping high probability transition trigrams to form the career paths data, the high probability transition defined by trigrams overlapping by at least two grams upon combination to provide a stable trajectory.

15. The predictive modeling system of claim 14, wherein the career path analyzer module further assigns a score to each career path in the career path data, wherein the score is computed based on probability of the n-grams that were used, a number of steps in the career path, and a rate of maturity gain.

16. The predictive modeling system of claim 15, wherein the career path data may be further enriched with marketability statistics computed by the marketability service module.

17. The predictive modeling system of claim 16, wherein the career paths data is stored in the career paths database by the career path analyzer module when the batch computing platform is in communication with the at least one application database.

18. The predictive modeling system of claim 16, wherein the career path service module retrieves the career pathing algorithm of the career path service module retrieves the career path for provision to the user device from the career path data in the career paths database.

19. A method for determining marketability of a user with a predictive modeling system having at least one application services server having a marketability service module and a career path service module, the at least one application services server including a processor and a memory on which process-executable instructions are embodied, the at least one application services server in communication via the Internet with at least one user device, the at least one application services server generating a single page application for viewing on the at least one user device, the marketability services module configured to generate a marketability score for provision to the user on the single page application upon receiving a request from the user device, and the career path service module configured to provide a career path to the user on the single page application upon received a request from the user device, at least one application database stored on a memory, including a job market statistics database in which a plurality of marketability scores are stored, and a career paths database in which a plurality of career path transitions are stored, the job market statistics database in communication with the marketability service module, and the career paths database in communication with the career path services module, a data lake receiving parsed and classified jobs data from a jobs ingress pipeline, the data lake including at least one memory having a jobs postings database in which the parsed and classified jobs data is stored, a resumes database in which parsed and classified resume data is stored, an enriched jobs posting database, and an enriched resumes database, a batch computing platform in intermittent communication with at least one application database and the data lake, the batch computing platform including at least one processor and a memory on which process-executable instructions are embodied, the batch computing platform including a job posting enrichment module, a resume enrichment module, a job market analyzer module, and a career path analyzer module, the job posting enrichment module receiving the parsed and classified jobs data from the jobs posting database and computing enriched jobs data and writing the enriched jobs data to the enriched jobs posting database, the resume enrichment module receiving the parsed and classified resumes data from the resumes database and computing enriched resumes jobs data and writing the enriched resumes job data to the enriched resumes database, the job market analyzer module configured to receive the enriched jobs postings data and the enriched resumes data and supply jobs market statistics to the job market statistics database, and the career path analyzer configured to receive the enriched resumes data and supply career paths data to the career paths database, the method comprising the steps of:
receiving, by the marketability service module, inputs including a specific occupation of interest being viewed by the user on the user device, and the job markets statistics data and the saved scores in the job market statistics database;
determining, by the marketability service module, a raw skill score for the user, and a raw degree score for the user;
calculating, by the marketability service module, a modified z-score for a skill component of the user, and a modified z-score for a degree component of the user;
summing the weighted scores to yield the marketability score for the user, wherein the marketability score is a number; and
fitting the marketability score for the user to one of a plurality of buckets based on the range the marketability score falls into, with the buckets identified as developing, fair, intermediate, above average, and desirable, the buckets providing the user with an efficient indication of the user's marketability relative to the specific occupation of interest.

20. A method for predicting a probability of a career path transition with a predictive modeling system having at least one application services server having a marketability service module and a career path service module, the at least one application services server including a processor and a memory on which process-executable instructions are embodied, the at least one application services server in communication via the Internet with at least one user device, the at least one application services server generating a single page application for viewing on the at least one user device, the marketability services module configured to generate a marketability score for provision to the user on the single page application upon receiving a request from the user device, and the career path service module configured to provide a career path to the user on the single page application upon received a request from the user device, at least one application database stored on a memory, including a job market statistics database in which a plurality of marketability scores are stored, and a career paths database in which a plurality of career path transitions are stored, the job market statistics database in communication with the marketability service module, and the career paths database in communication with the career path services module, a data lake receiving parsed and classified jobs data from a jobs ingress pipeline, the data lake including at least one memory having a jobs postings database in which the parsed and classified jobs data is stored, a resumes database in which parsed and classified resume data is stored, an enriched jobs posting database, and an enriched resumes database, a batch computing platform in intermittent communication with at least one application database and the data lake, the batch computing platform including at least one processor and a memory on which process-executable instructions are embodied, the batch computing platform including a job posting enrichment module, a resume enrichment module, a job market analyzer module, and a career path analyzer module, the job posting enrichment module receiving the parsed and classified jobs data from the jobs posting database and computing enriched jobs data and writing the enriched jobs data to the enriched jobs posting database, the resume enrichment module receiving the parsed and classified resumes data from the resumes database and computing enriched resumes jobs data and writing the enriched resumes job data to the enriched resumes database, the job market analyzer module configured to receive the enriched jobs postings data and the enriched resumes data and supply jobs market statistics to the job market statistics database, and the career path analyzer configured to receive the enriched resumes data and supply career paths data to the career paths database, the method comprising the steps of:
receiving, by the career path analyzer, inputs including a pool of parsed and enriched resumes based on an occupation taxonomy from the data lake, and user profile from a profiles database of the at least one application database;
extracting, by the career path analyzer, transitions for each item in the pool, and classifying each employment position to an occupation in the occupation taxonomy, extracting all occupation transitions (n-grams), and keeping all bigrams and trigrams;
aggregating, by the career path analyzer, the occupation transitions, calculating a number of times a specific set of transitions are observed, calculating an average time between each of the transitions, and calculating continuation/precedence probability for each of the transitions;
finding, by the career path analyzer, usable transitions by filtering out transitions with a low overall sample count, filtering out transitions with a low continuation or precedence probability, only keeping transitions with a predetermined occupation maturity gain, and filtering out transitions that contain loops; and
combining, by the career path analyzer, the transitions by overlapping high probability transition trigrams to form the career paths data, the high probability transition defined by trigrams overlapping by at least two grams upon combination to provide a stable trajectory.
